(19) United States
(12) Patent Application Publication
(10) Pub. No.: US 2002/0184068 A1
(43) Pub. Date: Dec. 5, 2002

(54) Communications network-enabled system and method for determining and providing solutions to meet compliance and operational risk management standards and requirements

(76) Inventors: Krish R. Krishnan, Ballston, VA (US); Sunil Rekhi, Oakton, VA (US); Eric Steinmiller, Bethesda, MD (US)

Correspondence Address: STAAS & HALSEY LLP, 700 11TH STREET, NW, SUITE 500, WASHINGTON, DC, 20001, US

(21) Appl. No.: 09/871,690

(22) Filed: Jun. 4, 2001

(51) Int. Cl. G06F 17/60

(52) U.S. Cl. 705/8

(57) ABSTRACT

A communications network-enabled method and apparatus for determining and providing solutions to meet compliance and risk management standards and requirements, including asking, via a communications network, a user a plurality of questions in an electronic format that adapts a subsequent question based on a user inputted answer to a previous question, determining applicability of at least one of a law, a statute, a regulation, an industry standard and a policy based on the answer, determining enabling information, customized to the user's industry and assisting the user in prioritizing and allocating user resources to comply with the at least one of a law, a statute, a regulation, an industry standard and a policy that was determined to be applicable, based on the answer.

### BACKGROUND OF THE INVENTION

1. Field of the Invention

The invention relates to a system and method for enabling a communications network to ask questions, determine compliance and risk management standards and requirements and assist a user in complying with the compliance and risk management standards and requirements.

2. Description of the Related Art

Restaurants, gas stations, factories, hospitals, etc. are subject to scrutiny by different kinds of regulators, customers, investors, as well as other interested parties. The restaurants, gas stations, factories, hospitals, etc. are located on a parcel of land that is subject to government jurisdiction and industry standards, and is usually referred to as a company location. The company location is subject to multiple layers of government regulation by being located on a parcel of land. In addition, government regulations can apply to a company location by virtue of chemicals stored on site or processes performed on site. Companies can have many company locations, or just one.

If a company is a small or medium sized business having a single company location, compliance and risk management standards and requirements, such as Occupational Safety and Health (OSHA) regulations and customer expectations of openness and accountability can be difficult, because the company is not large enough to afford specialized staff. If a company is a large business and has many locations, compliance and risk management standards and requirements, such as investor expectations for litigation avoidance can be difficult because compliance and risk management standards and requirements vary from company location to company location due to differences in governmental statutes, regulations and ordinances as well as industry standards. Each company location is responsible for complying with all local statutes, regulations and ordinances as well as industry standards, and meeting all expectations.

In addition, the compliance and risk management standards and requirements change as new rules are promulgated, new agreements are reached and new laws are passed. While each compliance standard and requirement that changes has an implementation period, keeping up with such changes can be difficult and time consuming. One way of keeping up with such changes is to read periodical references, as well as news monitoring services, to stay knowledgeable about changes in compliance and risk management standards and requirements. The periodical references and news monitoring services are generally directed toward a specific industry, such as textiles, petroleum, or dry cleaning. The periodical references directed toward a specific industry are sometimes known as vertical industry publications, because they refer to compliance and risk management standards and requirements that are applicable to the specific industry, regardless of the size of the company.

FIG. 1 is a schematic drawing showing that each company location 100 must deal with many different persons, sometimes called stakeholders, with many different expectations. Workers 110 work at a location and expect a safe work environment, adequate training and supplies to do their job, and that they will be able to continue working. Customers 120, which can also be called distributors, transporters and messengers shop at a company location and expect that the location is safe for them, the products they buy are safe and reasonably priced and that the location complies with all local statutes, regulations and ordinances. Regulators visit company locations and expect that the location will comply with all local, regional, state and national statutes, regulations and ordinances. Investors 150 investigate a company, occasionally visiting a company location expecting that the company is profitable and complies with all local, regional, state and national statutes, regulations and ordinances. The many different stakeholders involved having different expectations can be difficult and expensive for a company to keep track of. One area of particular difficulty is compliance and risk management standards and requirements 175.

Compliance and risk management standards and requirements 175 come into being as suppliers 165 deliver supplies to the company location 100. The workers 110 convert the supplies into products 112 using business processes 116. The workers may in addition keep records 114 and are supervised by supervisors 130. Executives 140 and investors 150 that may or may not visit the site and may guide the supervisors 130. The actions of the workers 110, supervisors 130, executives 140 and suppliers 165 are generally governed by compliance and risk management standards and requirements. One exemplary source of compliance and risk management standards and requirements is government statutes and regulations. Other examples of compliance and risk management standards and requirements can include industry standards and risk management techniques.

Statutes include statutes passed by the international and national government, statutes passed by a regional or state government. Ordinances can include laws passed by a local, city or county government. Regulations include regulations promulgated by national agencies, standards set by standards organizations, rules of voluntary organizations, policies set by a company and Standard Operating procedures set by supervisors and executives within a company. Well known regulations include those promulgated by the United States Environmental Protection Agency (EPA), the United States Occupational Safety and Health Administration (OSHA), standards set by the American Petroleum Institute (API) and the National Institute for Occupational Safety and Health (NIOSH). These statutes, regulations and ordinances are large, intricate and difficult for the ordinary company to understand and implement at company locations.

FIG. 2 is a schematic drawing showing several other sources of compliance and risk management standards and requirements 175. The compliance and risk management standards and requirements can come from regulatory and interpretive actions 180, market and industry standards 190, and corporate standards 200. Corporate standards 200 can come from best or preferred management practices 202, union bargaining agreements 204, risk management standards 206, or any other agreement or policy that a company decides to implement. Market and Industry Standards 190 can come from the International Organization of Standards (ISO) 192, the American National Standards Institute (ANSI) 194, the Dow Jones Sustainability Index 196, the American Petroleum Institute (API), or any other known source for market and industry standards.

Regulatory and interpretive actions 180 can come from the United Nations 182, the European Union 184, the United States Government 186, or any other governmental or quasi-governmental organization that sets standards or passes laws. For example, the European Union 184 can issue European Union Directives 185 as well as ratifying or accepting country directives 183. In the United States, laws can be passed at the National 189, state 187 or local 188 level. In addition, in the United States, some laws create organizations such as the Environmental Protection Agency (EPA) 210, the Occupational Safety and Health Administration (OSHA) 220 and the Security and Exchanges Commission (SEC) 230. These organizations can issue regulations that have the force of law. In addition, the judiciary 240 can issue opinions and decide cases that interpret the existing laws and regulations.

Various solutions have been proposed to help a company communicate with the different persons and comply with all types of statutes, regulations and ordinances. Specifically, one solution is to automate the process of storing and maintaining Material Safety Data Sheet (MSDS) information. Another solution is to make regulations available through computers. Alternately, man hours based consulting models may be used to keep up with changing regulations and to apply the regulations to a specific situation.

### SUMMARY OF THE INVENTION

A first exemplary embodiment of the invention includes a communications network-enabled method, apparatus and computer medium storing a computer program for determining which compliance and risk management standards and requirements apply to a company location and providing those compliance and risk management standards and requirements. Various exemplary embodiments can use a web server, a company computer, a private computer, an application service provider, a wireless provider or a rented computer. The various exemplary embodiments can be accessed from any computer connected to the Internet, an Intranet, a wireless network, or have access restricted to a selected computer through a network-enabled communications network. Additional exemplary embodiments can benchmark performance, analyze risk-related behavior and improve overall risk management.

A network-enabled communications network can be any communications network that can transfer information to the various exemplary embodiments. One example is the World Wide Web. Another example is a wireless access device, such as a cellular telephone, that sends information to compliance and risk management device located on a proprietary computer. A communications network-enabled system can also be a communications network, such as the Internet, that can transfer information to the various exemplary embodiments.

The various exemplary embodiments include determining and providing compliance and risk management standards and requirements by asking, using a communications network-enabled method, a user a plurality of questions in an electronic format that adapts a subsequent question based on a user inputted answer to a previous question, determining the applicability of at least one of a law, a statute, a regulation, an industry standard and a policy based on the answer, determining enabling information, customized to the user's industry, assisting the user in prioritizing and allocating user resources to comply with the at least one of a law, a statute, a regulation, an industry standard and a policy that was determined to be applicable, based on the answer. Various other exemplary embodiments can determine and provide risk management mechanisms and methods for reducing risk.

The exemplary embodiments begin by having a communication network user enter company specific information through a series of questions. Many of the questions determine the applicability of compliance and risk management standards and requirements, and the answers determine additional questions. The compliance and risk management standards and requirements can be based on any known or later conceived industry standard, agreement, law or regulation. Other questions relate to a company's current compliance status, or compliance tasks that need to be done.

Once a user has answered the questions, several of the exemplary embodiments determine the applicability of various compliance and risk management standards and requirements, and dates by which the compliance and risk management standards and requirements must be met. The applicability information and dates are then translated into enabling information. The user can then assign other users or themselves, to complete tasks necessary to meet the applicable requirements, using the enabling information. Additionally, the user can track the completion of tasks, and the status of compliance using the exemplary embodiment.

The enabling information may be training that needs to be completed, supplies that are needed, or tasks that must be completed. Laws, statutes, regulations, industry standards and policies can mandate the task, the training and the supply. The training required may have already been taken, in which case the various exemplary embodiments record information about the completed training such as date completed, person completed by, etc. The supply required may already be on hand or ordered, in which case the various exemplary embodiments record information about the supply ordering such as date completed, person completed by, etc. The task to be completed may have already been completed by the user, in which case the various exemplary embodiments record information about the completed task such as date completed, person completed by, etc.

The training may consist of an online training, a classroom training, a certification, a test, test for sizing or any other now known or later developed training. If the training is an online training, various exemplary embodiments may directly offer the training, or may provide an automatic link to a source for the training. If the training is classroom training, the exemplary embodiment may offer a link to sign up for the training. If the training is a certification or test, the exemplary embodiment may offer and administer the test, or offer links to allow the user to sign up for the test or certification. The training may then be recorded after completion, either by the exemplary embodiment recording completion, the user certifying completion, or the source certifying completion. If the training is a test to check that a piece of equipment is sized correctly, the various exemplary embodiments may record the results of the sizing.

The supply needed may be any of a safety supply, a spill supply, a test equipment, a measuring equipment, a permit, a repair part or any other now known or later developed supply. The various exemplary embodiments may offer links for ordering the supply. The various exemplary embodiments may also offer information about the requirements related to the supply, and whether a specific supply meets those requirements.

Further, the enabling information may be a policy to be implemented, a plan to be prepared, a test to be performed, a report to be to be at least one of filed, saved and created or information that needs to be found. The user can then prepare the plan, perform the test, file, save or create the report, or find the information and record the information in one of the exemplary embodiments. The recorded information can then be reported to investors, executives or customers through on-line documents, paper reporting, or any other now know or later devised method. In several exemplary embodiments, the answers to the plurality of questions can create location, company or responsible person profiles which provide risk management data to understand, analyze and enable better performance and more effective hedging of risk.

Various exemplary embodiments can also have the questions based on chemicals, products, and structures located at a location. Other exemplary embodiments can have the questions relate to risk management, auditing checklists, corporate standards, market and industry standards and regulatory and interpretive actions.

In addition, the various exemplary embodiments can determine a score for relative compliance with the compliance and risk management standards and requirements. The score can then be used for ranking company locations within a company, a company within an industry, or any other uses a ranking system now known or later devised.

The invention centers around being a process oriented approach that allows companies to comply with the increasingly bewildering array of regulations and requirements. A company's ability to comply will be a key strategic advantage that allows some companies to prosper. The various exemplary embodiments offer an integrated, systematized information commerce suite of compliance and training content, information management and electronic marketplace venues via a communications network such as the Internet, or company intranets. Additional communications networks, such as wireless networks or mobile phones can also be used for notifications and remote data entry. The ability to use a variety of communications networks gives the various embodiments versatility and quick responsiveness, without sacrificing the inherently comprehensive and reliable dissemination of information, customized to a users industry. Further, the ability to utilize a platform independent, scalable architecture enables extensive customization to a users needs in an interactive iterative manner, concentrating on the users business processes through the use of the enabling information gained from the user inputted answers to the questions.

### BRIEF DESCRIPTION OF THE DRAWINGS

These and other objects and advantages of the invention will become more apparent and more readily appreciated from the following description of the preferred embodiments, taken in conjunction with the accompanying drawings, in which:

FIG. 1 is a related art diagram of the relationship of a company location to customers, regulations, suppliers and investors;

FIG. 2 is a related art diagram of the sources of compliance and risk management standards and requirements;

FIG. 3 is a diagram of an exemplary embodiment illustrating the relationship of a compliance and risk management device to customers, regulations, suppliers and investors;

FIG. 4 is a diagram of an exemplary embodiment of a compliance and risk management device;

FIG. 5 is a diagram of layers within an exemplary embodiment of a compliance and risk management device;

FIG. 6 is a diagram of an exemplary relationship of elements within an application layer;

FIG. 7 is a diagram of the method used by several exemplary embodiments in determining compliance;

FIG. 8 is a diagram of the method used by several exemplary embodiments in determining compliance and risk management information using an exemplary embodiment of the invention;

FIG. 9 is a flow diagram of the questions using an exemplary embodiment of the invention;

FIG. 10 is a flow diagram of answering questions related to compliance;

FIG. 11 is an exemplary screen shot for entering tasks;

FIG. 12 is a flow diagram of answering questions related to risk;

FIG. 13 is an exemplary screen shot for managers;

FIG. 14 is an exemplary screen shot for executives/policy makers;

FIG. 15 is an exemplary screen shot for workers;

FIG. 16 is an exemplary screen shot for scheduling training;

FIG. 17 is an exemplary screen shot for purchasing training;

FIG. 18 is an exemplary screen shot for viewing action items;

FIG. 19 is an exemplary screen shot for changing MSDS templates;

FIG. 20 is an exemplary screen shot for viewing MSDS information;

FIG. 21 is an exemplary screen shot for selecting and searching for standard operating procedures;

FIG. 22 is an exemplary screen shot for ranking and viewing standard operating procedures;

FIG. 23 is an exemplary screen shot for purchasing supplies;

FIG. 24 is an exemplary table arrangement and linking for a database of one embodiment of the invention;

FIG. 25 is an exemplary material transportation table;

FIG. 26 is an exemplary material storage container table;

FIG. 27 is an exemplary inventory record table;

FIG. 28 is an exemplary material regulation limits table;

FIG. 29 is an exemplary material use and disposition table;

FIG. 30 is an exemplary personnel table;

FIG. 31 is an exemplary material and MSDS table;

FIG. 32 is an exemplary regulation table;

FIG. 33 is an exemplary course training record table;

FIG. 34 is an exemplary student table;

FIG. 35 is an exemplary regulation change table;

FIG. 36 is an exemplary incident log table;

FIG. 37 is an exemplary manufacturer table;

FIG. 38 is an exemplary material aquisition table;

FIG. 39 is an exemplary items table; and

FIG. 40 is an exemplary credit account table.

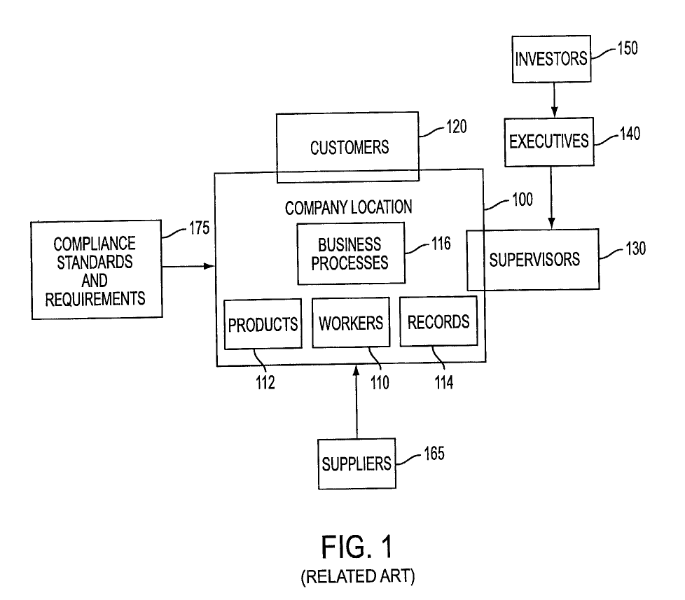

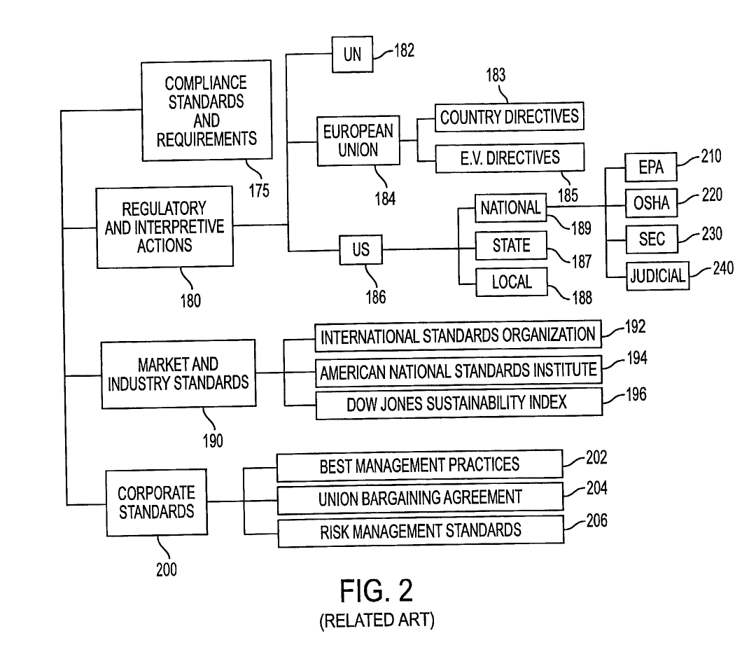

### DETAILED DESCRIPTION OF THE PREFERRED EMBODIMENTS

Reference will now be made in detail to the preferred embodiments of the present invention, examples of which are illustrated in the accompanying drawings, wherein like reference numerals refer to like elements throughout.

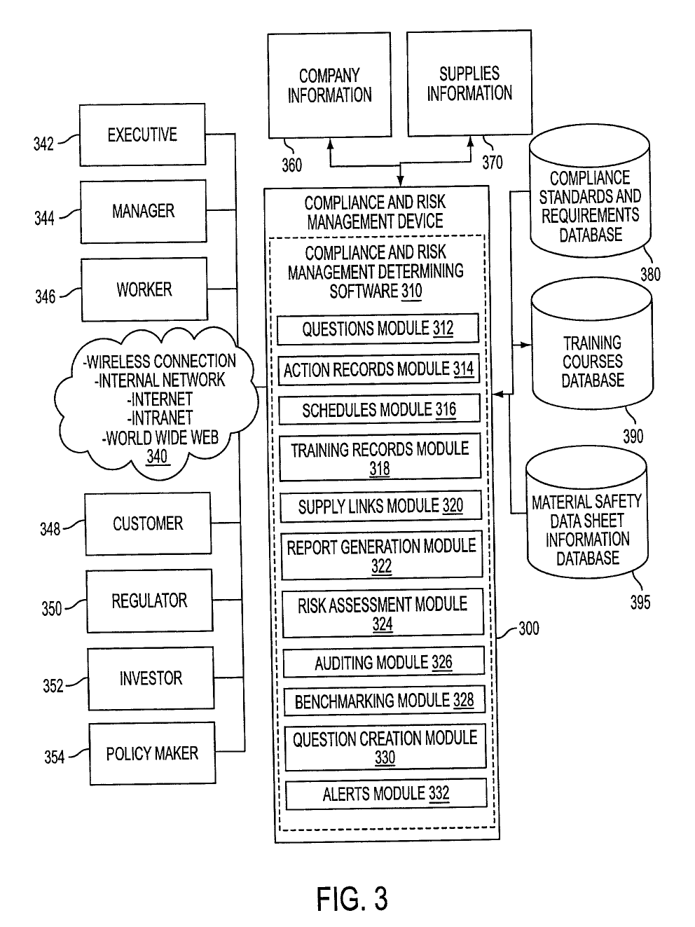

FIG. 3 is an exemplary diagram of a system using a compliance and risk management device 300. The compliance and risk management device 300 contains compliance and risk management determining software 310. The compliance and risk management determining software 310 contains questions module 312, action records module 314, schedules module 316, training records module 318, supply links module 320, report generation module 322, risk assessment module 324, auditing module 326, benchmarking module 328, question creation module 330 and alert module 332. The compliance and risk management device 300 connects to executive 342, manager 344, worker 346 and video network 340. The network 340 can be, e.g., a wireless connection, an internal network, an internet, an intranet or the world wide web. The compliance and risk management device 300 also connects to customer 348, regulator 350, investor 352 and policy maker 354 via the network 340. The compliance and risk management device 300 connects to compliance and risk management standards and requirements database 380, training courses database 390 and material safety data sheet information database 395. The compliance and risk management device 300 also connects to company information 360 and supplies information 370.

The compliance and risk management device 300 shown is an object oriented representation of the invention. Those skilled in the art will understand that standardized hardware components may be used to achieve the indicated functionality in any of the included drawings. In addition, the modules shown may be combined, eliminated or added to without modifying the spirit and scope of the invention. For example, network 340 can be any now known or later devised method of communicating, including using wireless connections, fiber optic connections, copper connections, broad band connections including DSL, and cable, internet protocol oriented communications networks including the Internet, an Intranet, the world wide web, a proprietary network, a microwave network, connection oriented or connectionless networks, using ATM, frame relay, SONET or any other protocol. In addition, intermediate devices such as a firewall, network storage devices, translation and other security devices are not shown for simplicity. Their absence does not indicate that those devices are not useful, helpful or included as part of various exemplary embodiments of the invention. Lastly, the compliance and risk management device 300, for example, is shown for convenience as a single device with the compliance and risk management standards and requirements database 380, the training courses database 390 and the material safety data sheet database 395 shown as separate devices. Various exemplary embodiments may use multiple devices or combine the devices to achieve the same functionality without departing from the spirit and scope of the invention.

The various exemplary embodiments are built on an independent, extensible and scalable architecture based on Java 2.0, utilizing Java servlets, Java server pages, Enterprise Java Beans, Extensible Markup Language, Oracle 8i and light directory access protocol. The various exemplary embodiments are designed to quickly and easily deploy into targeted vertical industries and within multiple regulatory domains.

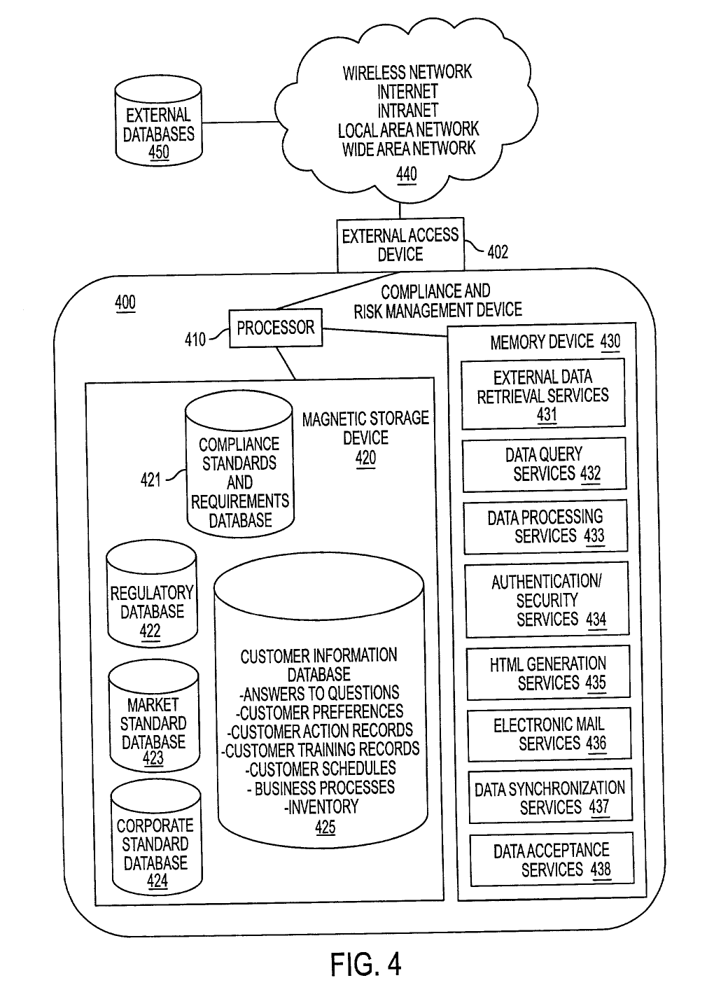

FIG. 4 shows an exemplary compliance and risk management device 400. The compliance and risk management device 400 contains external access device 402, processor 410, memory device 430 and magnetic storage device 420. Memory device 430 contains external data retrieval services 431, data query services 432, data processing services 433, authentication and security services 434, HTML generation services 435, electronic mail services 436, data synchronization services 437 and data acceptance services 438. Magnetic storage device 420 contains compliance and risk management standards and requirements database 421, regulatory database 422, market standard databases 423, corporate standard databases 424 and customer information databases 425. Customer information database 425 contains answers to questions, customer preferences, customer action records, customer training records, customer schedules, business processes and inventory. The compliance and risk management device 400 accesses external databases 450 through network 440, which is connected to external access device 402.

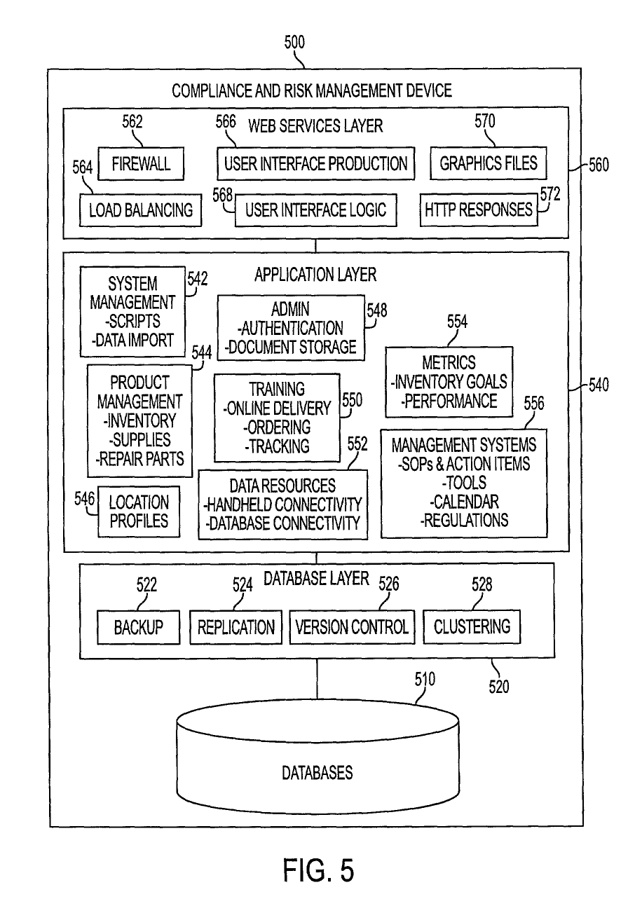

FIG. 5 shows another exemplary compliance and risk management device 500. The compliance and risk management device 500 contains web services layer 560, application layer 540, database layer 520 and databases 510. Database layer 520 contains data 522, replication 524, version control 526 and clustering 528. Application layer 540 contains system management 542, product management 544, location profile 546, administration 548, training 550, data resources 552, metrics 554, and management systems 556. System management 542 contains scripts and data import modules. Product management 544 contains records of inventory, supplies and repair parts. Administration 548 contains authentication and document storage. Training 550 contains on-line delivery, ordering and tracking modules. Data resources 552 contain handheld connectivity and database connectivity. Metrics 554 contains inventory goals, risk management data, resource use data, waste management and emissions data and performance modules. Management systems 556 contain standard operating procedures and action items, tools, calendars and regulations. The web services layer 560 contains firewall 562, load-balancing 564, user interface production 566, user interface logic 568, graphics files 570 and HTTP responses 572.

Thus, a user can access compliance and risk based resources, training, management systems, metrics and products. The various exemplary embodiments can be web based compliance solutions that are accessed though standard web browser software. In addition, various exemplary embodiments can be configured to work on internal company networks, computers or mainframes.

Various exemplary embodiments can be packaged individually for cost or efficiency reasons. For example, a diagnostic portion of one exemplary embodiment of the invention can provide a tool to map the status of compliance across multiple company locations, and develop a status report of compliance needs over time. In addition, various what-if scenarios can be made available to simplify the process for users that are not simulation experts. The diagnostic portion can also develop appropriate checklists for companies to track their compliance performance.

A secondary use of various exemplary embodiments allows for the data recorded about individual companies to be aggregated and used to indicate the companies compliance status compared to other companies in the same vertical industry, or in all industries.

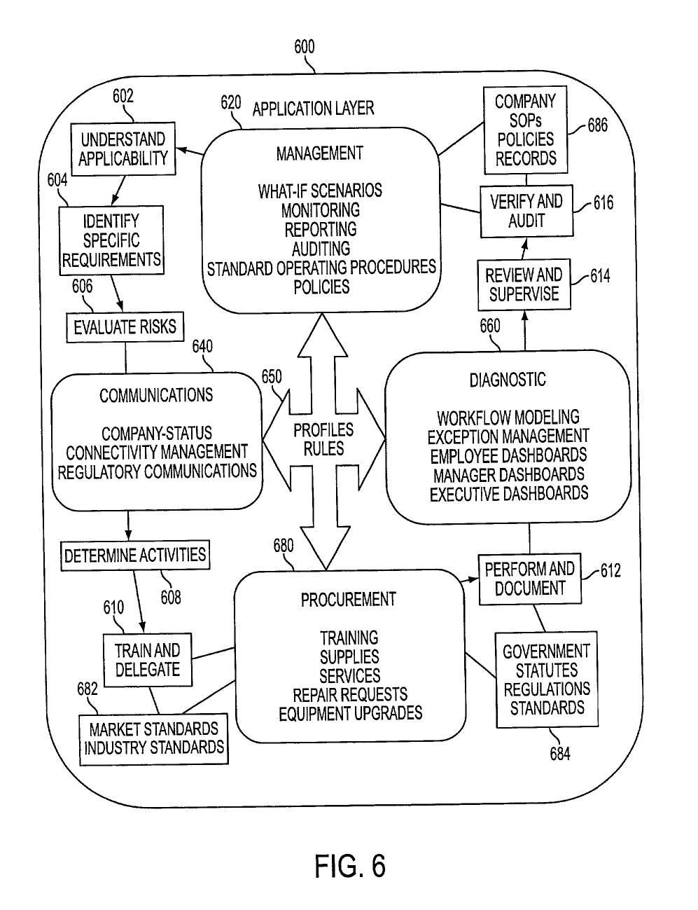

FIG. 6 shows an exemplary logic formation for application layer 600. Application layer 600 contains management 620, communications 640, profile and rules 650, diagnostic 660 and procurement 680. The application layer 600 implements logic that includes understand applicability 602, identify specific requirements 604, evaluate risks 606, determine activities 608, train and delegate 610, perform and document 612, review and supervise 614 and verify and audit 616. Application layer 600 utilizes company standard operating procedures, company policies, company records 686, government sections, government regulations, government standards 684, market standards and industry standards 682.

The exemplary architecture is composed of three basic tiers as described above and additional tiers for back end services. The various exemplary embodiments can give a presentation level user interface that provides hypertext markup language and secure transaction services. The various exemplary embodiments can use an application engine featuring the BEA WebLogic business logic server and a robust messaging tool. In addition, various exemplary embodiments can use portions of Oracle database engines and Veritas Volume manager/replication. In other various exemplary embodiments, back end services can use mail, log files, Veritas NetBackup and data replication/encryption.

For any company, compliance is a continuous process of staying in tune with ever changing regulations, standards, customer requirements and corporate policies. Companies have to continually adapt people, processes and information to the current environment. Companies at the same time need to be more efficient, and achieve higher and more consistent compliance.

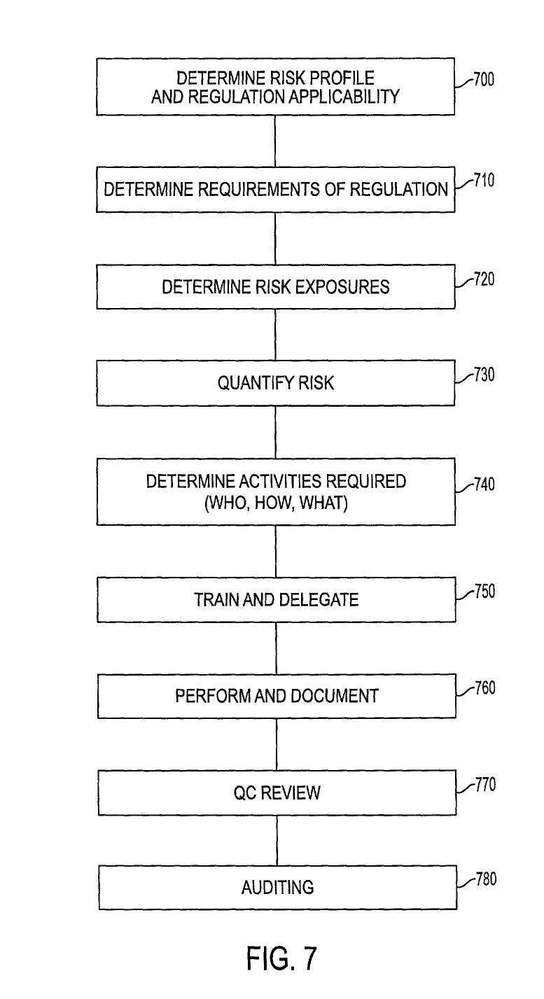

FIG. 7 is a diagram showing a method of achieving compliance according to an exemplary embodiment of the invention. The method begins with determine risk profile and regulation applicability 700. In determine risk profile and regulation applicability 700, a specific set of regulations and other guidance is studied and evaluated for applicability to a specific company location. The method then continues to determine requirements of regulation 710.

An exemplary gas station using an embodiment of the invention might start by reviewing the regulations on underground storage tanks, the API standards for tanks, dispensers, piping, measuring product sold, and quality standards for gasoline both received and sold. The exemplary gas station would then have to continue by learning other required standards such as OSHA requirements for flammable liquid handling, ISO 9000 certification, and county spill prevention equipment standards. In addition, if the exemplary gas station is a franchise of a major gas producer, the station managers and employees will have to be familiar with branding requirements, bonding requirements, and ordering procedures for everything from repair equipment to gasoline.

In determine requirements of regulation 710, the regulations and other guidance is converted into a concrete set of tasks, supplies and training required. Within the body of regulations there are specific rules that must be followed and others that are not applicable. The exemplary embodiment generates interactive questions to assist and determine the specific rules a company location must follow. The specific rules are captured and used to determine the concrete set of actions required to improve or maintain compliance with the regulations and other guidance. The method then continues to determine risk exposures 720.

For the exemplary gas station, this might translate into needing to print out a leak detection report every morning, manually checking the level of gasoline and water in all of the tanks, and verifying that cash registers contain enough change. In addition, equipment may be broken and require repair parts and services.

In determine risk exposures 720, the risk exposure associated with the specific rules, regulations and other guidance is conducted to determine an appropriate response. The appropriate response must incorporate expertise and knowledge to assist the evaluation and enable management decision-making. Determining risk exposures 720 can include conducting what-if scenarios. The method then continues to quantify risk 730.

The exemplary gas station might therefore conduct a spill response what-if exercise, to determine amounts and types of spill equipment that would be required. In addition, storage for the spill equipment can be determined. Areas of special sensitivity, such as nearby wetlands, can be identified.

In quantify risk 730, the results of determine risk exposures 720 are evaluated. The results can be evaluated in any manner now known or later conceived. For example, what-if scenarios can be used to determine the reasonable maximum damage that can occur if there is a failure to meet one of the compliance and risk management standards and requirements. The method then continues to determine activities required 740.

The exemplary gas station can use the information gained through the what-if exercise to determine amounts of damage that could be caused in various scenarios, the likelihood of the scenario happening, and other factors that place a human health and economic damage quantity on the results of the what-if scenario. In accordance with the exemplary embodiment of the invention this process can be sped up by supplying industry standard assumptions and costs to the results of the what-if scenario.

In determine activities required 740, an action plan to implement changes in a procedure, policy, assessments or location operations is prepared. The action plan may consider such factors as time of implementations, cost of implementation and various strategies to implement the action plan. The method then continues to train and delegate 750.

In the exemplary gas station, the embodiment of the invention can be used to track the resulting tasks needing to be done and in formulating the action plan. In addition, the exemplary embodiments may suggest additional procedures that are needed and keep track of the changes to procedures. Various other exemplary embodiments can also provide example action plans, procedures policies and assessments.

In train and delegate 750, personnel are assigned to implement the change in procedures, policies, assessments or operations. The personnel may require additional training to implement the changes. The training must be scheduled and funded. The personnel must also be enrolled in and attend the training. Once personnel are scheduled for training, are attending training, or have completed training, depending on the particular action plan, additional steps may be begun. The method then continues to perform and document 760.

The exemplary embodiment can assist in providing and scheduling training. Various exemplary embodiments may link to other training providers, or may provide the training internally. Various exemplary embodiments may also provide for tracking of training completed. The exemplary embodiments can also record actions, the results of actions, and communicate the records to various parties interested in the company location, as noted above.

In perform and document 760, the modified activities are performed and their effectiveness is documented. The basis of achieving compliance and risk reduction is carrying out assigned tasks. The assigned tasks must be added through detailed records. Maintaining the detailed records is laborous and time consuming. The exemplary embodiment allows for automated record keeping and reporting. The method then continues to quality control (QC) review 770.

In quality control review 770, the records are evaluated and compared to risk factors. The changes in procedure, policy, assessments and location operations can then be evaluated in terms of risk reduction, increased compliance and more effective operations. The method then continues to auditing 780.

In auditing 780, erroneous data, missing data and effectiveness can be determined. Management can then determine whether additional changes are necessary or whether to return to previous practices. The method can then end or return to determine risk profile and regulation applicability 700.

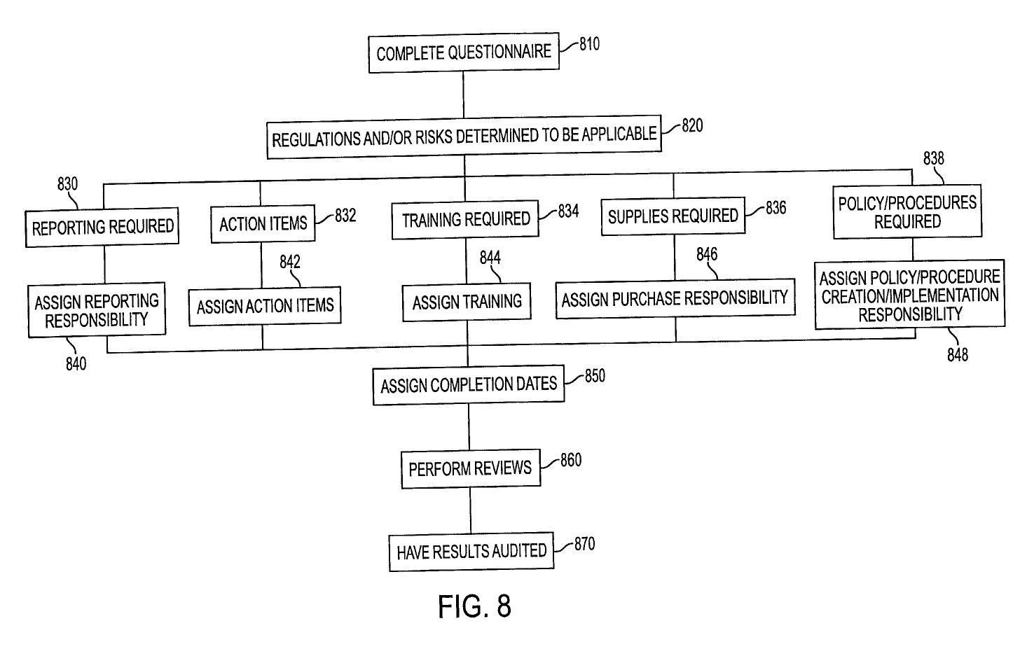

FIG. 8 is a flow diagram of an exemplary method used in determining compliance and risk management information. The method begins at complete questionnaire 810. In complete questionnaire 810, a series of questions are completed that determine the applicability of compliance and risk management standards and requirements. The method then continues to regulations and risks determined to be applicable 820.

In regulations and risks determined to be applicable 820, the questions asked in complete questionnaire 810, are applied to the selected compliance and risk management standards and requirements and the compliance and risk management standards and requirements determined to be applicable are determined. The method then continues to at least one of reporting required 830, action items 832, training required 834, supplies required 836 and policy/procedures required 838.

In reporting required 830, any reports required by the selected regulations are displayed to the user. The reports along with any information needed in the reports are displayed to the user for verification, information and quality control purposes. The method then continues to assign reporting responsibility 840. In assign reporting responsibility 840, the reports are assigned to an employee of the company. The method then continues to assign completion dates 850.

In action items 832, any actions required by the selected regulations are displayed to the user. The action along with any information to be gathered during the action is displayed to the user for verification, information and quality control purposes. The method then continues to assign action items 840. In assign action items 840, the actions are assigned to an employee of the company. The method then continues to assign completion dates 850.

In training required 830, any training required by the selected regulations are displayed to the user. The training along with any information about the training are displayed to the user for verification, information and quality control purposes. The method then continues to assign training 844. In assign training 844, the training needed is assigned to the employee of the company that needs to complete the training. The method then continues to assign completion dates 850.

In supplies required 830, any supplies required by the selected regulations to be on the company location or available to company employees are displayed to the user. The supplies along with any information needed in ordering the supplies are displayed to the user for verification, information and quality control purposes. The method then continues to assign purchasing responsibility 846. In assign purchasing responsibility 846, the responsibility for purchasing the supplies is assigned to an employee of the company. The method then continues to assign completion dates 850.

In policy/procedures required 838, any policies or procedures required by the selected regulations to be documented by the company are displayed to the user. The policies and procedures along with any information needed to be included in the policies/procedures are displayed to the user for verification, information and quality control purposes. The method then continues to assign policy/procedure creation/implementation responsibility 848. In assign reporting responsibility 840, the reports are assigned to an employee of the company. The method then continues to assign completion dates 850.

In assign completion dates 850, dates are associated with any previously mentioned actions and recorded. Various tasks may be delayed to allow time for training, for personnel availability, or any other known reasons related to scheduling personnel and tasks. The method then continues to perform reviews 860.

In perform reviews 860, the user is allowed to review the reporting required, action items, training required, supplies required, policy/procedures required as well as any completion dates assigned. In addition the user can review any of the above-mentioned actions that have been completed as well as reviewing any of the above-mentioned actions that need to be completed. The method then continues to have results audited 870.

In have results audited 870, the results are displayed to a user for auditing the reporting completed, the action items completed, the training completed, the supplies purchased and the policies/procedures that have been created/implemented. The method then returns to complete questionnaire 810, or ends.

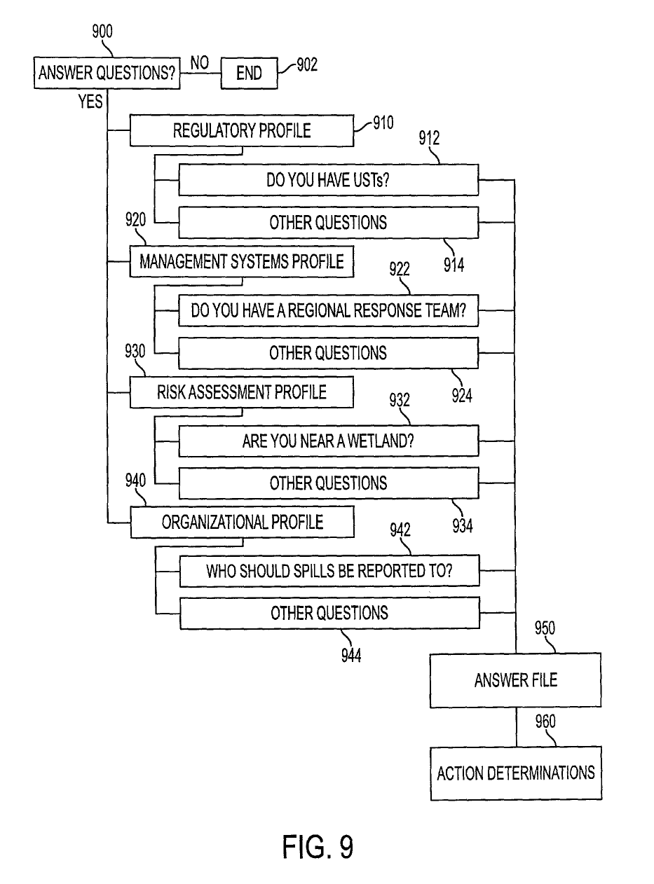

FIG. 9 is a flow diagram illustrating one exemplary embodiment of the questions asked to produce an answer file 950. The method begins in answer questions 900 and follows a decision tree approach. In answer questions 900, a determination is made whether to answer questions or not. If the questions are not going to be answered the method ends at end 902. If the questions are going to be answered, the method continues to select one of the regulatory profiles or risk management profiles.

The first profile that can be selected is regulatory profile 910. In regulatory profile 910, the first question can be “Do you have USTs?” 912. Other questions 914 can also be asked. The method then continues to create answers in answer file 950.

The second profile that can be selected is management systems profile 920. In management systems profile 920, the first question can be “Do you have a regional response team?” 922. Other questions 924 can also be asked. The method then continues to create answers in answer file 950.

The third profile that can be selected is risk assessment profile 930. In risk assessment profile 930, the first question can be “Are you near a wetland?” 932. Other questions 934 can also be asked. The method then continues to create answers in answer file 950.

The fourth profile that can be selected is organization profile 940. In organization profile 940, the first question can be “Who should spills be reported to?” 942. Other questions 944 can also be asked. The method then continues to create answers in answer file 950.

In answer file 950, the answers to all of the above questions are recorded in an answer file 950. Answer file 950 can be a database, a text file, or any other known or later created file format. The method then continues to action determination 960.

In action determinations 960, the answers in the answer file 950 are applied to the selected compliance and risk management standards and requirements and actions needed to comply with the compliance and risk management standards and requirements are determined.

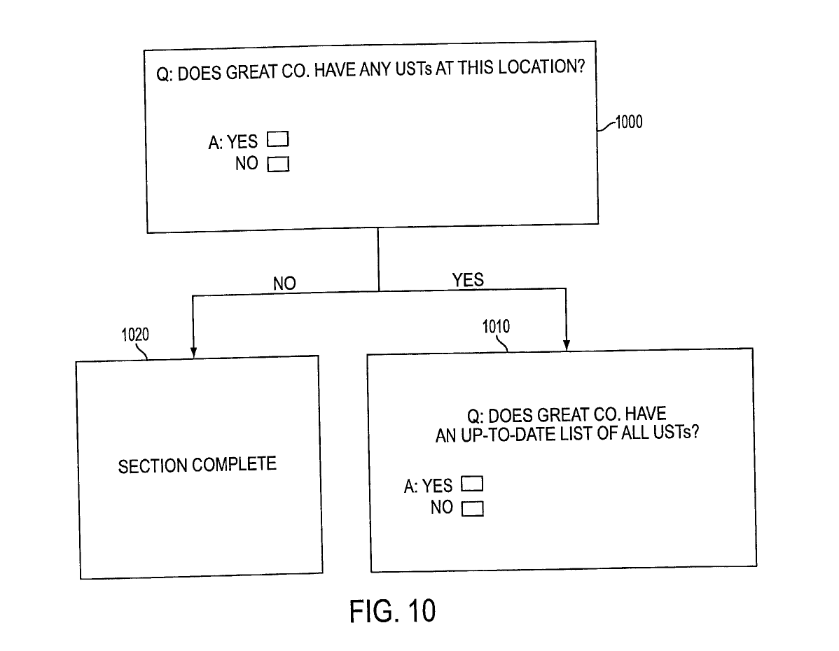

FIG. 10 illustrates an exemplary question with the subsequent question depending on the answer. The question “Does Great Co. have any USTs at this location?” along with answers “Yes” and “No” 1000 is displayed to the user. If the user selects “No” the method continues to section complete 1020. If the user selects “Yes”, the method continues to 1010. In 1010, the question “Does Great Co. have an up-to-date list of all USTs?” along with the answers “Yes” and “No” is asked. A subsequent question can then depend on the answer to 1010, or the method can end.

The processes described in FIGS. 7-10 are implemented in the following screen shots. The processes link and control the various exemplary screens shown, as well as similar screen shots that were omitted for clarity. Thus, additional screens of similar content can be added, and the exemplary screen shots shown can be modified as is well known in the art without departing from the spirit and scope of the invention.

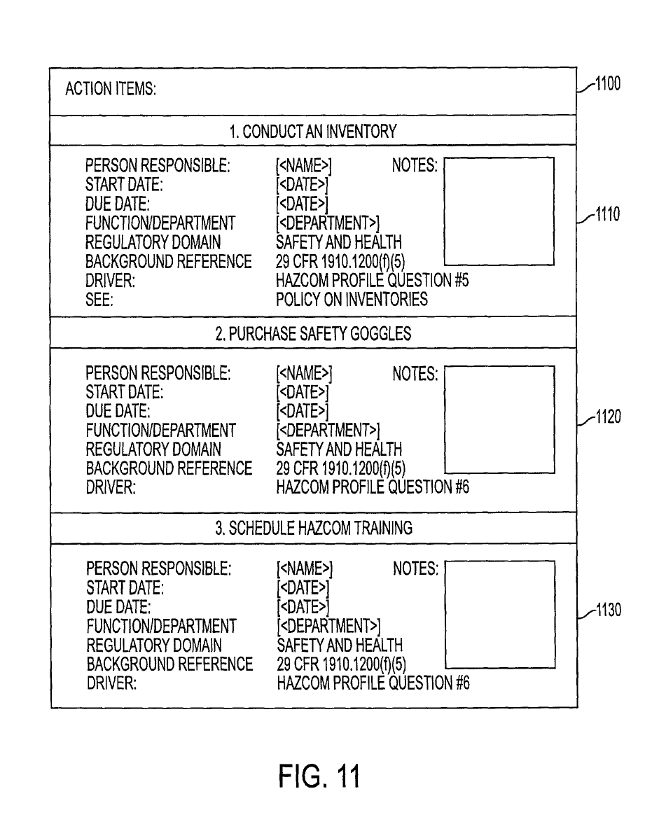

FIG. 11 is an exemplary screen shot of entering tasks. The user can utilize this exemplary screen shot to calendar and assign tasks that were determined as necessary by the questions about the applicability of the compliance and risk management standards and requirements. The action item entry screen 1100 can contain an inventory 1110, purchase safety panels 1120 and schedule hazcom training 1130. Multiple tasks can proceed from the answer of a single question. Similarly, several questions can result in a single task.

The conduct an inventory 1110 can contain person responsible, start date, due day, function/department, regulatory domain, background reference, driver, see and notes. The conduct an inventory 1110 can display that the regulatory domain is safety and health. The conduct an inventory 1110 can display the background reference 29 CFR1910.1200(f)(5). The conduct an inventory 1110 can display that the driver is hazcom profile question number 5. The conduct an inventory 1110 can display that the user should see a policy on inventories. The conduct an inventory 1110 can display that notes can be taken in a notes field.

The purchase safety goggles 1120 can contain person responsible, start date, due day, function/department, regulatory domain, background reference, driver and notes. The purchase safety goggles 1120 can display that the regulatory domain is safety and health. The purchase safety goggles 1120 can display the background reference 29 CFR1910.1200(f)(5). The purchase safety goggles 1120 can display that the driver is Hazcom profile question number 6. The purchase safety goggles 1120 can display that notes can be taken in a notes field.

The schedule hazcom training 1130 can contain person responsible, start date, due day, function/department, regulatory domain, background reference, driver and notes. The schedule hazcom training 1130 can display that the regulatory domain is safety and health. The schedule hazcom training 1130 can display the background reference 29 CFR1910.1200(f)(5). The schedule hazcom training 1130 can display that the driver is Hazcom profile question number 6. The schedule hazcom training 1130 can display that notes can be taken in a notes field.

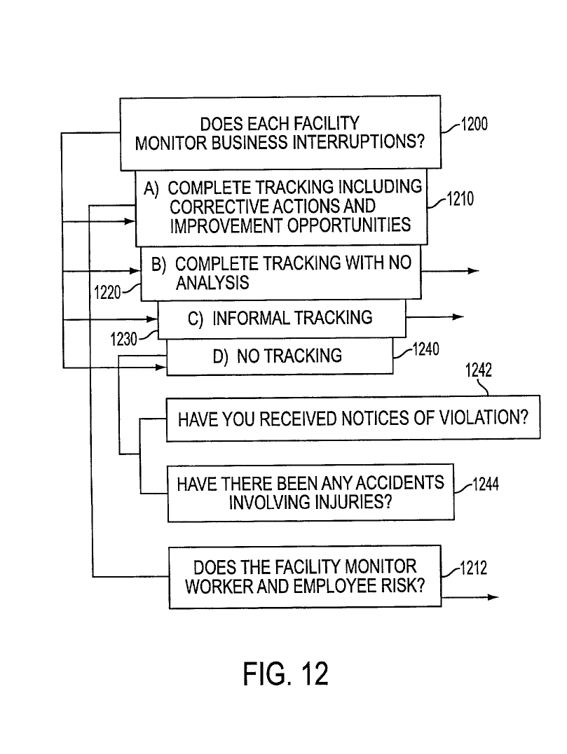

FIG. 12 is a flow diagram of answering questions related to risk. The method begins with the question “Does each facility monitor business interruptions?” 1200. The answer can be any one of A) complete tracking including corrective actions and improvement opportunities 1210, B) complete tracking with no analysis 1220, C) informal tracking 1230 and D) no tracking 1240.

If a user selects D) no tracking, a subsequent two questions are asked. The first subsequent question “Heave you received notices of violation?” 1242 can be asked next. Then, “Have there been any accidents involving injuries?” 1244 can be asked.

Alternately, if the user answers A) complete tracking including corrective actions and improvement opportunities 1210, a subsequent single question is asked. The single subsequent question can be “Does the facility monitor worker and employee risk?” 1212.

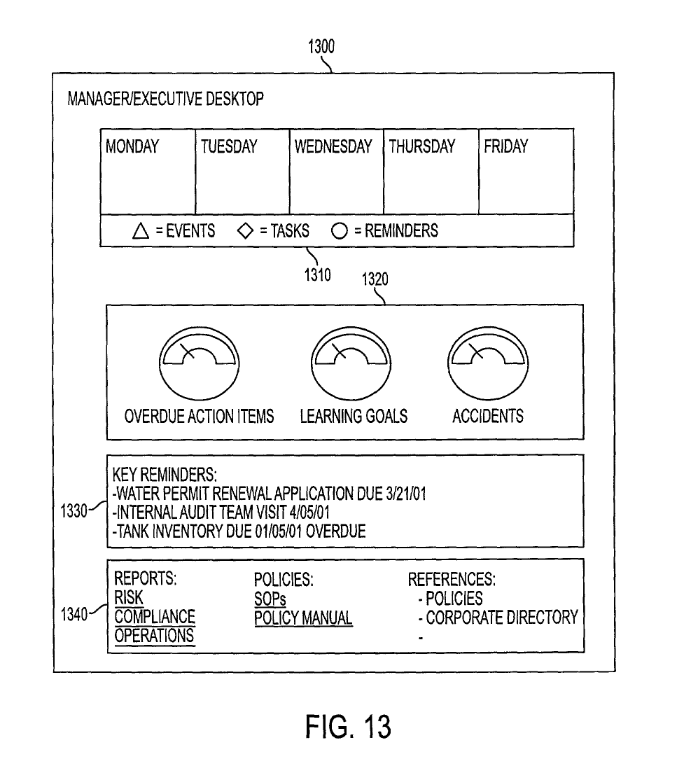

The following exemplary screen shots, FIGS. 13-23 illustrate exemplary screen shots that are used to implement the processes described above. Different views demonstrate how the comprehensive system can be broken up in exemplary embodiments to meet the scope and intent of the invention. Several of the following exemplary screen shots will illustrate how different purposes for looking at data can be embodied in varying exemplary screen shots.

FIG. 13 is an exemplary screen shot of a manager/executives desktop 1300. The managers/executives desktop can be used to provide a broad overview of the compliance status of a single company location. The managers/executive desktop 1300 can include a calendaring area 1310, a dashboard 1320, a reminders area 1330 and a reference area 1340.

The calendaring area 1310 can include areas for the days of the week, such as Monday, Tuesday, Wednesday, Thursday and Friday. The calendaring section can also contain a legends area that may show that events are shown as triangles, tasks are shown as diamonds and reminders are shown as circles. The calendaring area can place the appropriate symbol on the appropriate day to signify that the associated item is due on a particular day. The calendar can contain additional symbols showing that a task should begin on a particular day.

The dashboard area 1320 can contain an overdue action items area, a learning goals area and an accidents area. Each area can display information that relates the number of selected items on a scale. The scale can be particular to the company and the type of information.

The reminders area 1330 can contain reminders such as water permit renewal application due Mar. 21, 2001, internal audit team visit Apr. 5, 2001 and tank inventory due Jan. 5, 2001. The reminders area 1330 can also show the tank inventory due Jan. 5, 2001 is overdue.

The reference area 1340 can contain an area for reports, policies and references. The reports area can contain links to frequently used reports, recently completed reports or categories of reports, such as risk, compliance or operations. The policy area can contain links to frequently used, recently completed and categories of policies. The references area can contain links to policies, corporate directories, or any other information that is desired.

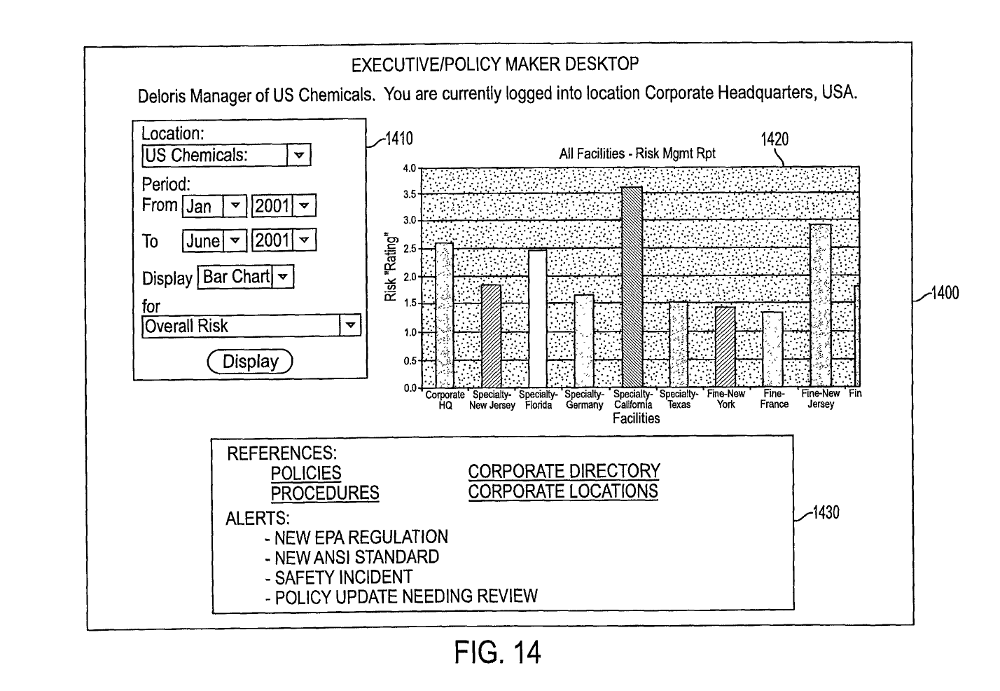

FIG. 14 is an exemplary screen shot of a executive/policy maker desktop 1400. The executive/policy maker desktop 1400 illustrates one way of viewing a company's compliance status across multiple locations, or in comparison with other companies. The executive/policy maker desktop 1400 can include a site selection area 1410, a graphing area 1420 and a reference area 1430.

The site selection area 1410 can include areas for location, period, display type, and type of information. The location area can contain a drop down selection box to select a particular company location. The period areas can contain start and end date selectors. The display are can contain a drop down or fill in box for selecting the format to display the information in. The type of information area can contain a drop down or fill in box for selecting the type of information to display.

The graphing area 1420 can contain a graphical representation of the information selected in the site selection area. Various types of information can be displayed depending on the type of information selected.

The reference area 1430 can contain an area for references and alerts. The references section can contain links to policies, corporate directories, or any other information that is desired. The alerts area can contain reference to new compliance standards, such as a new EPA regulation. The alerts area can contain reference to a new risk standard such as a new ANSI standard. The alerts area can contain a reference to recent events, such as a reported safety incident. The alerts area can contain a reference to tasks that are overdue, such as a policy update that needs to be reviewed.

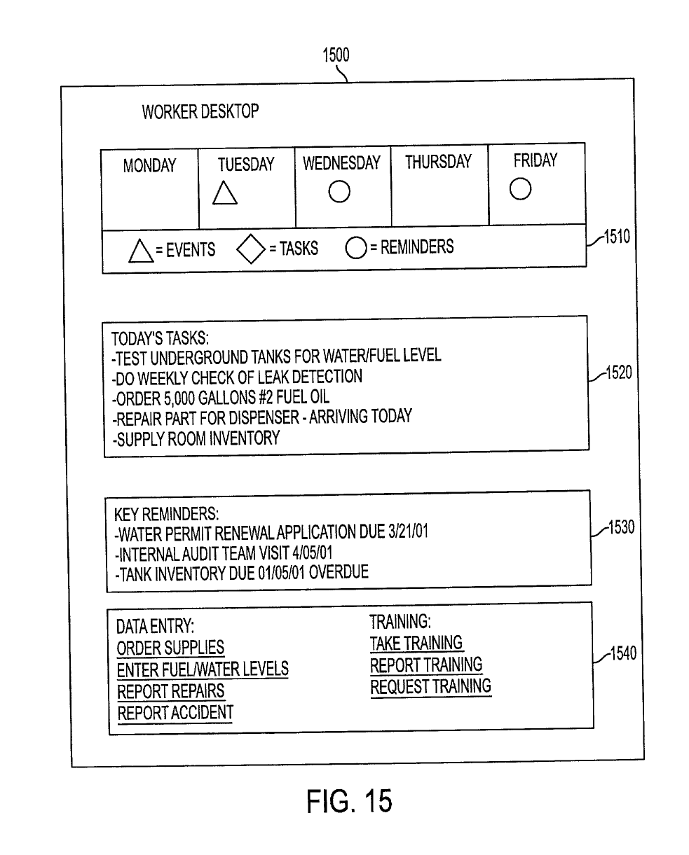

FIG. 15 is an exemplary screen shot of a worker desktop 1500. The worker desktop 1500 is one exemplary embodiment of a way of organizing information for those users primarily interested in data entry, and activities at a single location. The worker desktop 1500 can include a calendaring area 1510, a tasks area 1520, a reminders area 1530 and a reference area 1540.

The calendaring area 1510 can include areas for the days of the week, such as Monday, Tuesday, Wednesday, Thursday and Friday. The calendaring section can also contain a legends area that may show that events are shown as triangles, tasks are shown as diamonds and reminders are shown as circles. The calendaring area can place the appropriate symbol on the appropriate day to signify that the associated item is due on a particular day. The calendar can also contain additional symbols showing that a task should begin on a particular day.

The tasks area 1520 can contain daily tasks, such a test underground tanks for water/fuel level. The tasks area 1520 can contain periodic tasks to be completed, such as check leak detection. The tasks area can contain reminders of supplies that need to be ordered, such as ordering 5,000 gallons of number 2 fuel oil. The reminders area 1520 can contain reminders that supplies that have been ordered are scheduled to arrive. The tasks area 1520 can contain reminders of tasks that need to be accomplished with no specific date, or that are optional, such as supply room inventory.

The reminders area 1530 can contain reminders such as water permit renewal application due Mar. 21, 2001, internal audit team visit Apr. 5, 2001 and tank inventory due Jan. 5, 2001. The reminders area 1530 can also show the tank inventory due Jan. 5, 2001 is overdue.

The reference area 1540 can contain an area for data entry and training required. The data entry section can contain links to ordering supplies, entering fuel/water levels, reporting repairs and reporting accidents. The training section can contain links to take training, report training, and request training.

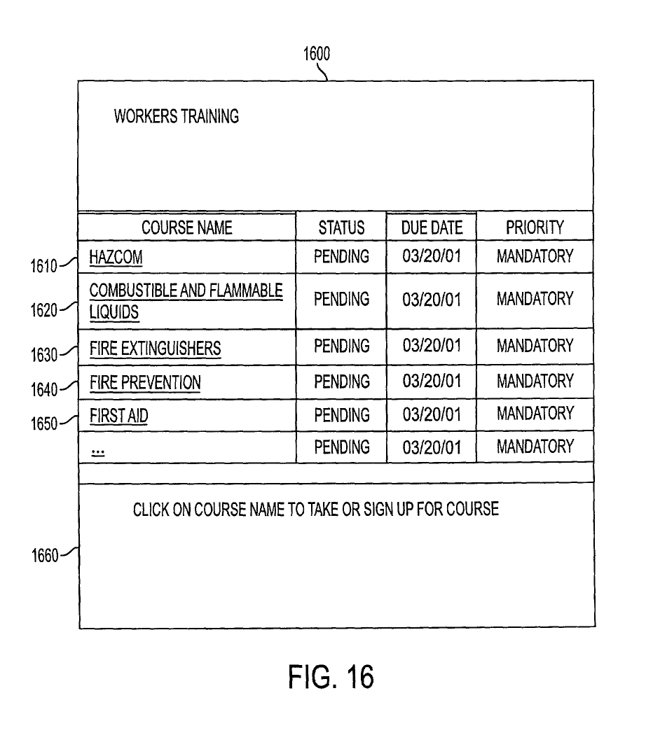

FIG. 16 is an exemplary screen shot for scheduling training 1600. The scheduling training 1600 can contain course names, status, due date and priority columns. The scheduling training 1600 can contain entries for training that needs to be accomplished, such as hazcom 1610, combustible and flammable liquids 1620, fire extinguishers 1630, fire prevention 640 and first aid 1650. The scheduling training 1600 can contain an area for instructions or comments 1660.

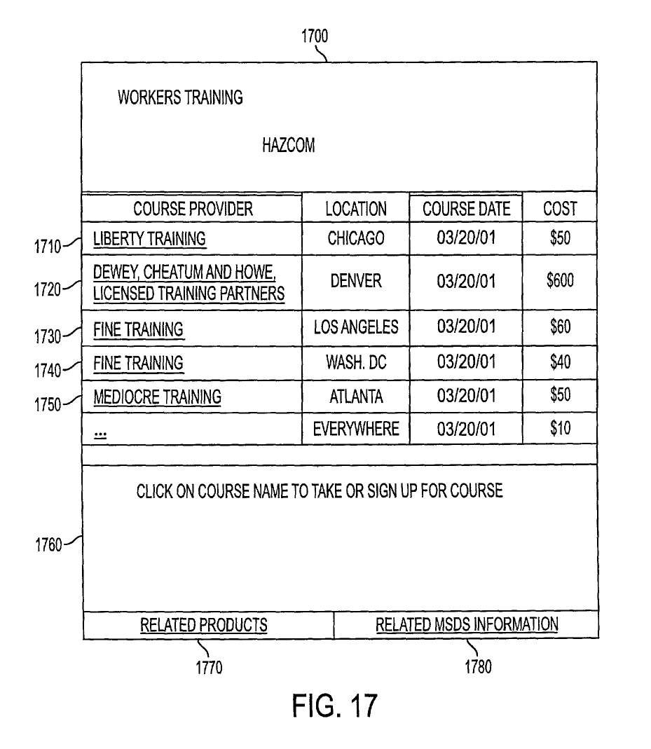

FIG. 17 is an exemplary screen shot for selecting training 1700. The selecting training 1700 can contain course providers, locations, course date and cost columns. The selecting training 1700 can contain entries for training providers, such as Liberty training 1710, Dewey, Cheatum and Howe, licensed training partners 1720, fine training 1730, fine training 1740 and mediocre training 1750. The selecting training 1700 can contain an area for instructions or comments 1760. The selecting training 1700 can contain an area for linking to related products for the training 1770. The selecting training 1700 can also contain an area for related material safety data sheets (MSDS) information 1780.

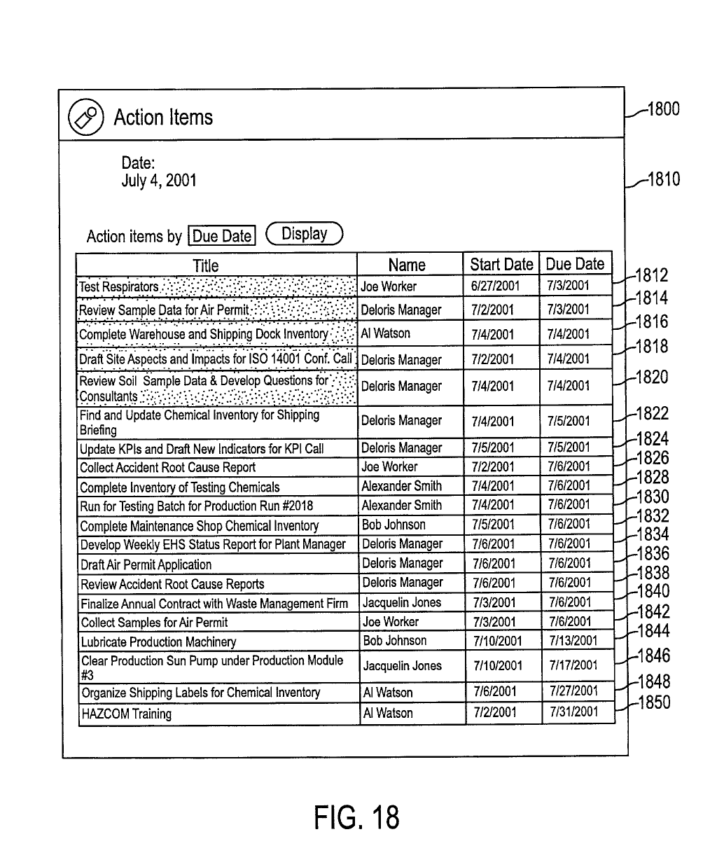

FIG. 18 is an exemplary screen shot for viewing action items 1800. The action items 1800 can contain a date area 1810, title, person responsible, start date and due date columns. The action items 1800 can contain entries such as test respirators 1812, review sample data for air permit 1814, complete warehouse and shipping dock inventory 1816, draft site aspects and impacts for ISO 14001 conference call 1818, review soil sample data and develop questions for consultants 1820, find and update chemical inventory for shipping briefing 1822, update KPIs and draft new engineers for KPI call 1824, collect accident root cause report 1826, complete inventory of testing chemicals 1828, run testing batch for production run 1830, complete maintenance shop chemical inventory 1832, develop weekly EHS status report for plant manager 1834, draft air permit application 1836, review accident root cause reports 1838, finalize annual contract with waste management firm 1840, collect samples for air permit 1842, lubricate production machinery 1844, clear production sump pump under production module 1846, organize shipping labels for chemical inventory 1848, HAZCOM training 1850. The action items can be highlighted if they are overdue, such as test 1812 review sample data for air permit 1814, complete warehouse and shipping dock inventory 1816, draft site aspects and impacts for ISO 14001 conference call 1818 and review soil sample data and develop questions for consultants 1820.

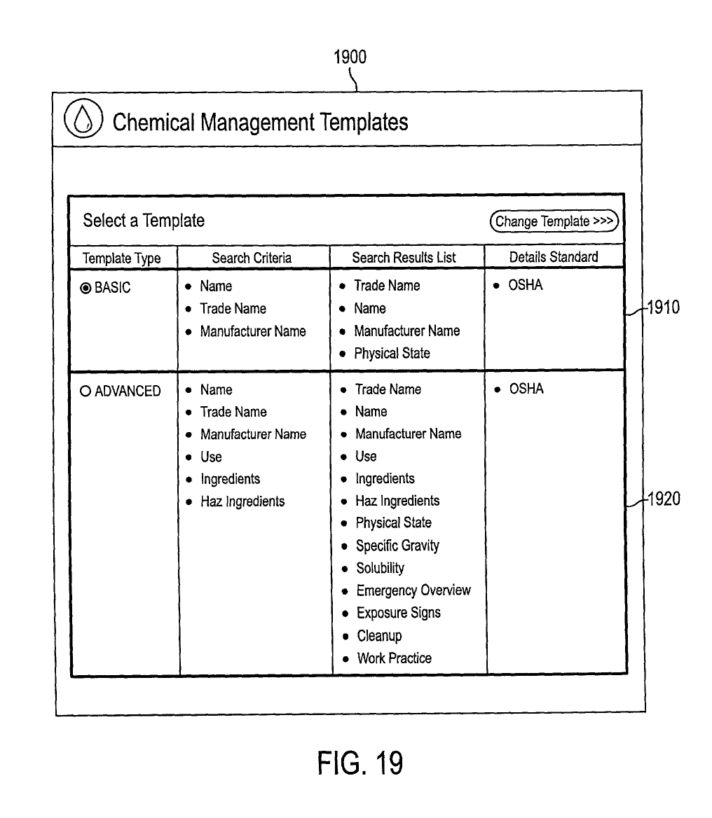

FIG. 19 is an exemplary screen shot for changing MSDS templates titled chemical management templates 1900. A chemical management template 1900 has a basic template selection area 1910 and an advanced template selection area 1920. The basic template selection area 1910 has several search criteria such as name, trade name and manufacturer name. The basic templates returns trade name, name, manufacturer name and physical state as the results of a search. The advanced template selection area 1920 includes additional search criteria such as use, ingredients and hazardous ingredients. The advanced template returns additional results such as use, ingredients, hazardous ingredients, specific gravity, solubility, emergency overview, exposure signs, cleanup and work practices.

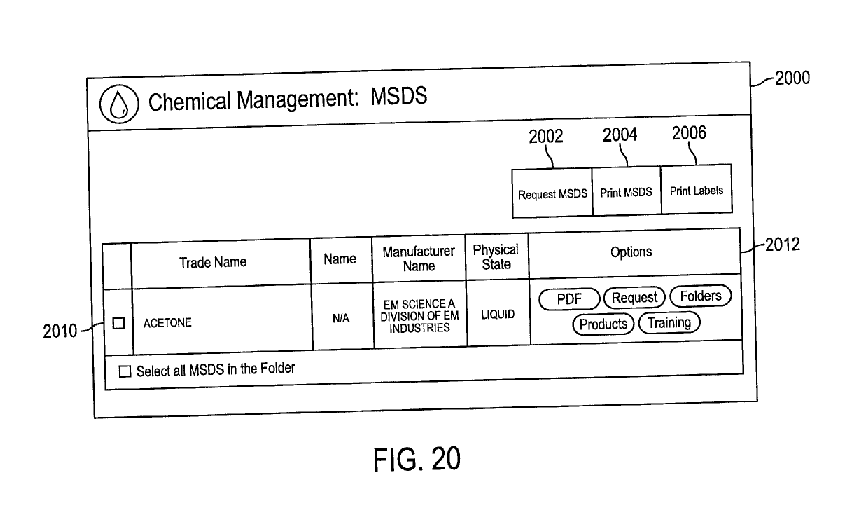

FIG. 20 is an exemplary screen shot for viewing MSDS information 2000. The MSDS information 2000 can contain request MSDS information 2002, print MSDS 2004, print labels 2006, chemical information 2010 and options 2012. Chemical information 2010 can contain chemical information such as Acetone. Options 2012 can contain links to request a MSDS, products containing a selected chemical and training required for the selected chemical.

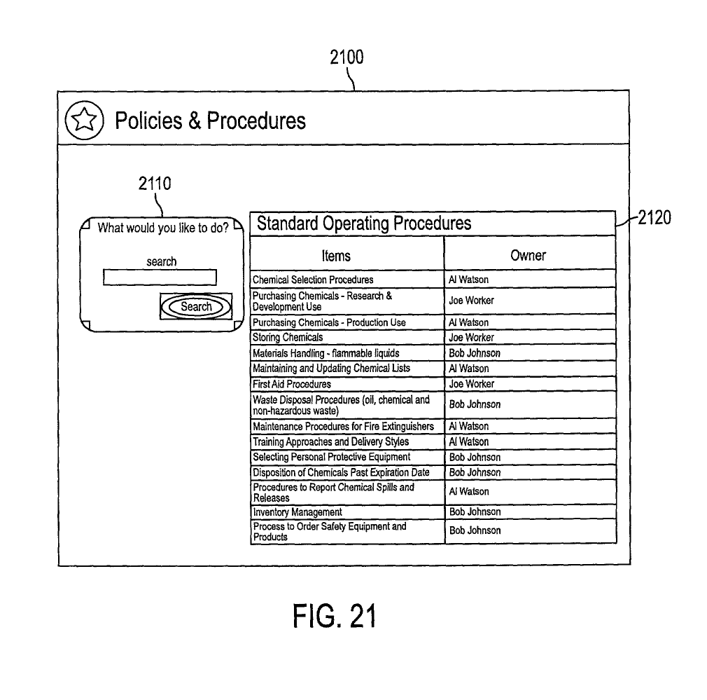

FIG. 21 is an exemplary screen shot for selecting and searching for policies and procedures 2100. The policies and procedures 2100 can contain search area 2110 and listing area 2120. Search area 2110 can contain text entry boxes, and execution buttons. Listing area 2120 can contain a listing of titles of documents that can link to the actual document and a listing of the owner of the document.

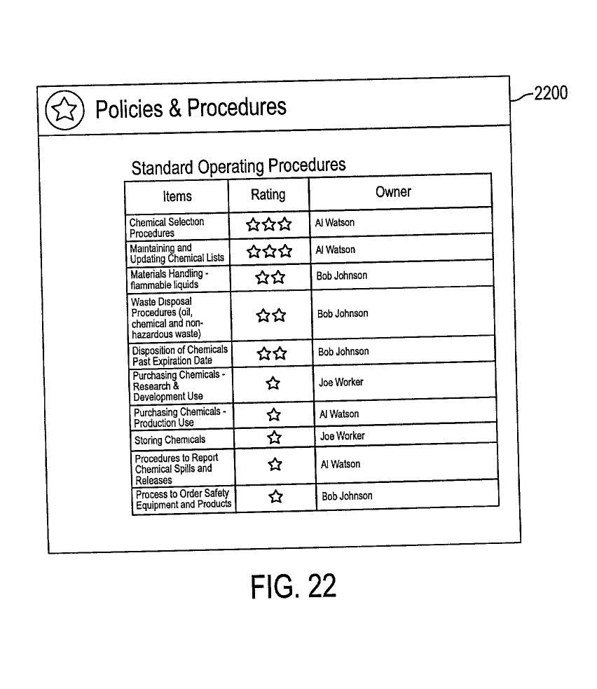

FIG. 22 is an exemplary screen shot for viewing and ranking standard operating procedures 2200. The standard operating procedures 2200 can contain items, rating and owner columns. The standard operating procedures can be ranked by a star system, and ordered according to descending order.

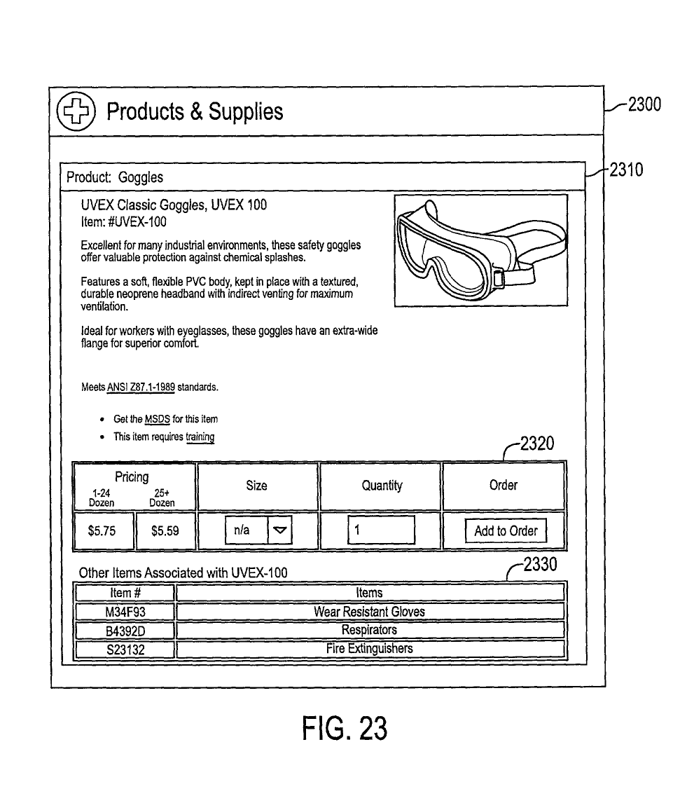

FIG. 23 is an exemplary screen shot for purchasing supplies 2300. Purchasing supplies 2300 can include product information area 2310, product order area 2320 and associated items area 2330. The product information area 2310 can contain text describing the product to be purchased. The product order area 2320 can contain pricing information, and information entry boxes for entering information relevant to the order. Associated items area 2330 can contain links to items related to the item described in product information area 2310. Associated items area 2330 can have item number and item description columns.

The above methods and screen shots are embodied in the following tables and table arrangement. While the following tables and table arrangement will enable one of ordinary skill to practice and utilize the invention, various modifications are possible without departing from the spirit and scope of the invention. For example, the following exemplary tables show one embodiment of the invention utilizing a relational database, such as Oracle, Access, or any other known or later devised relational database. However, one of ordinary skill will readily appreciate that the invention can be used in a dimensional or other type of database, without departing from the spirit and scope of the invention. The following tables and fields are designed to store information typical of the label assigned the table or field. As is well known, the fields can be text, numeric, Boolean, or any other type of field that is relevant for holding data of the type indicated below. In addition, various fields and tables can be added, combined or eliminated in accordance with the spirit and scope of the invention.

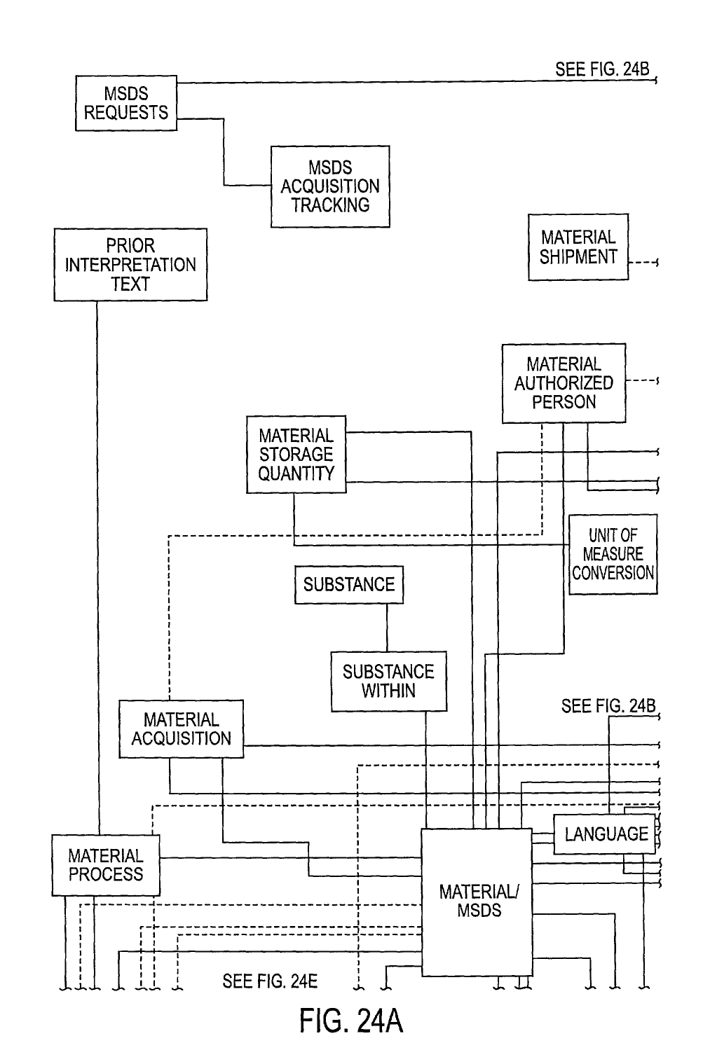

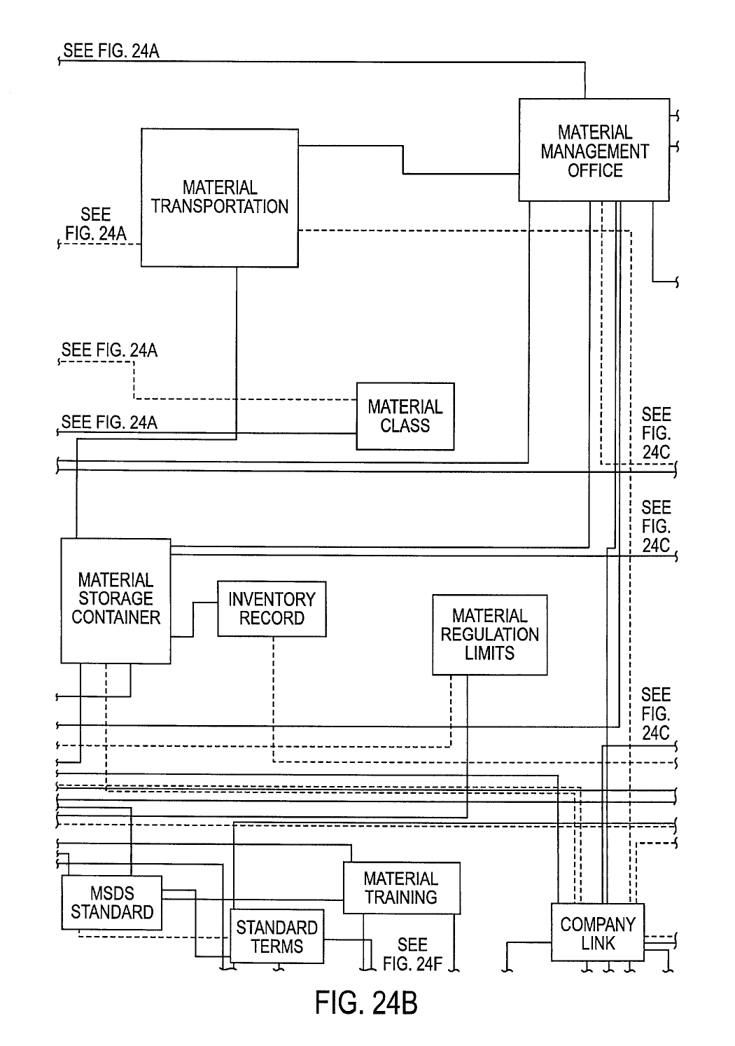

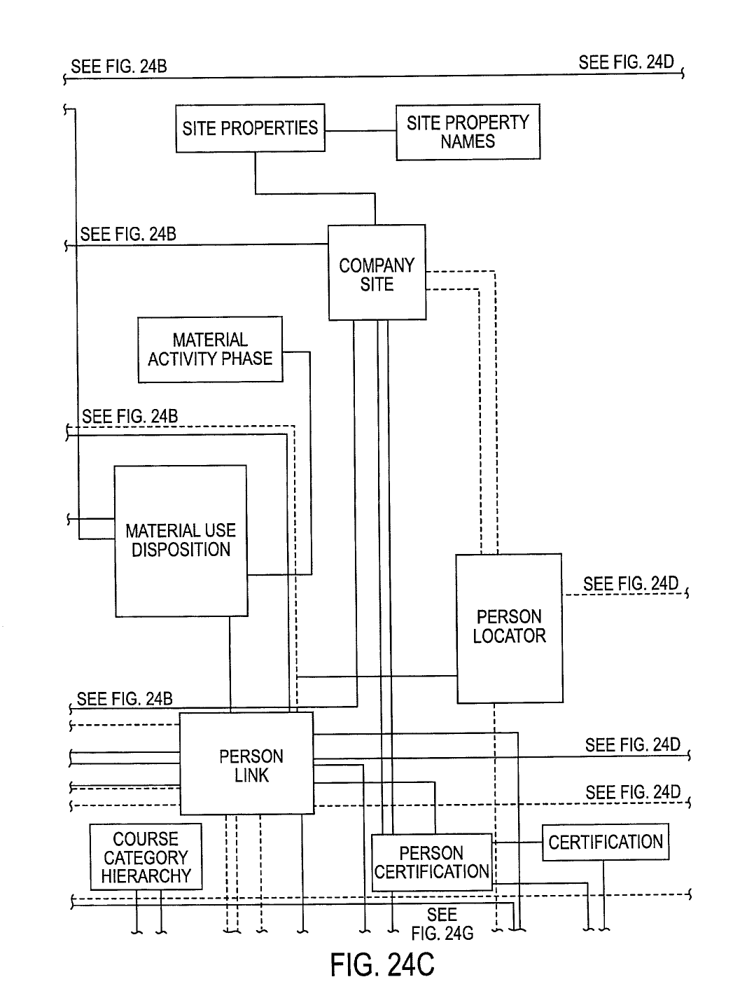

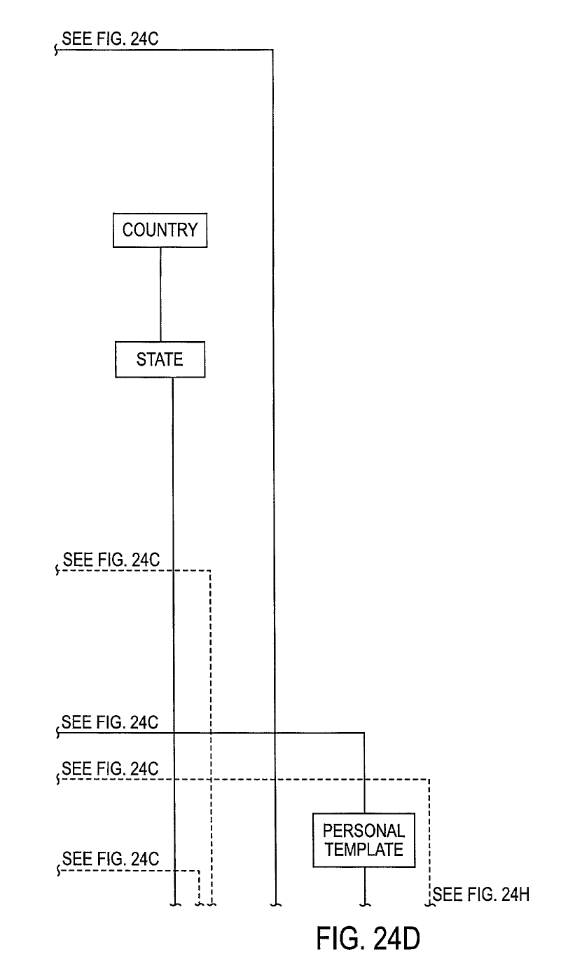

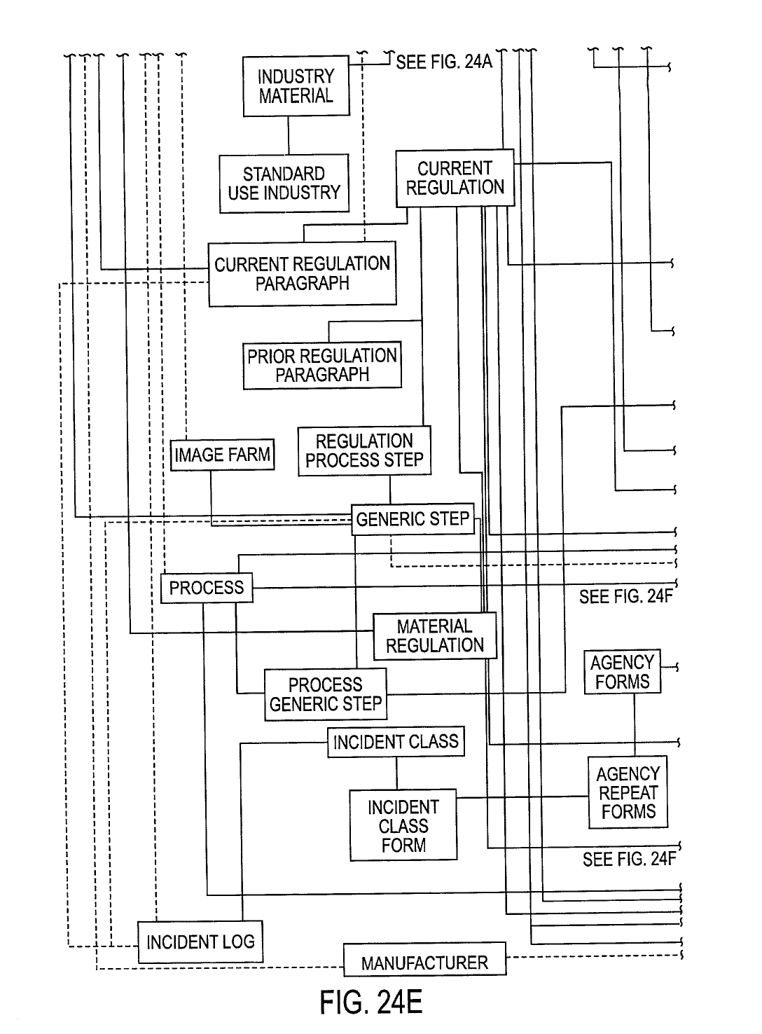

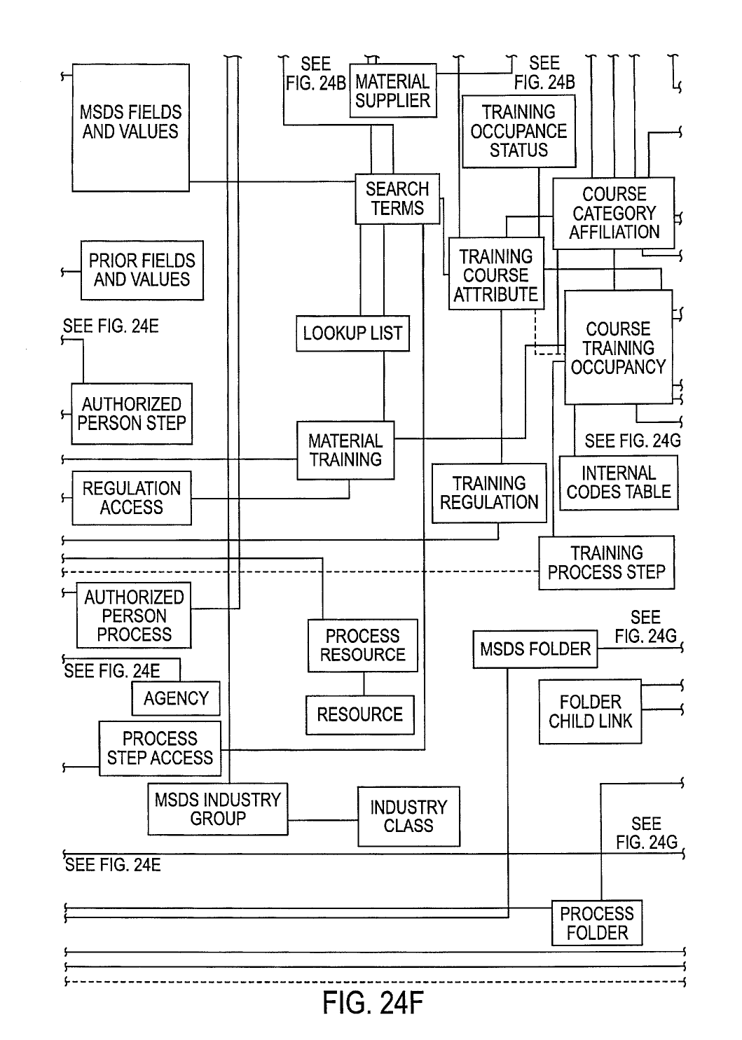

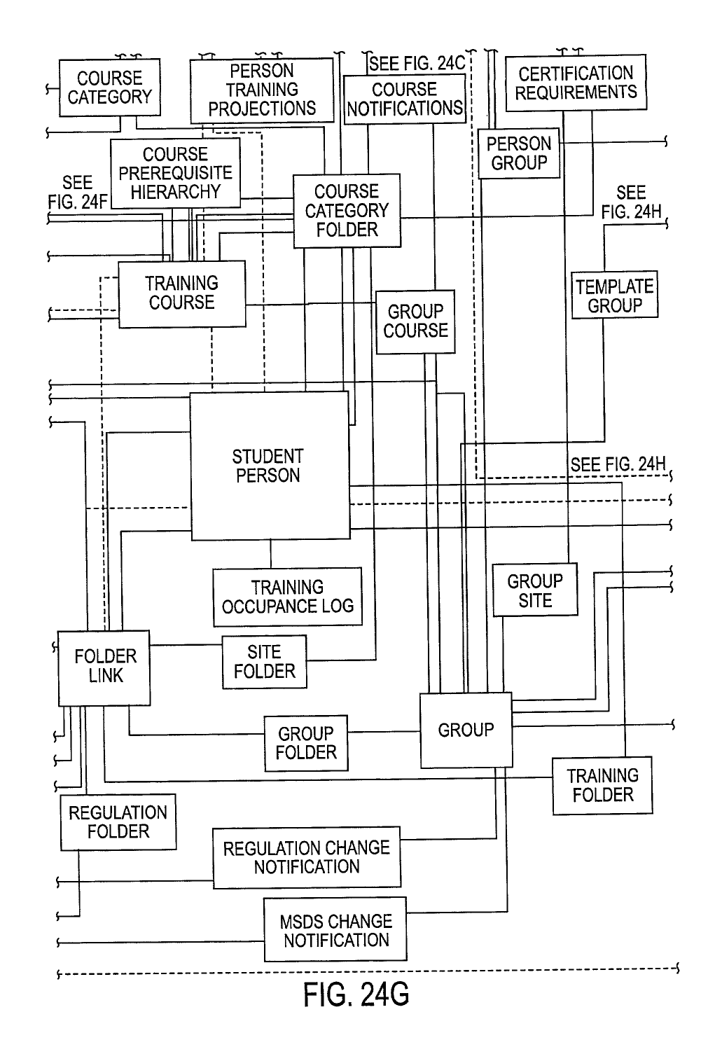

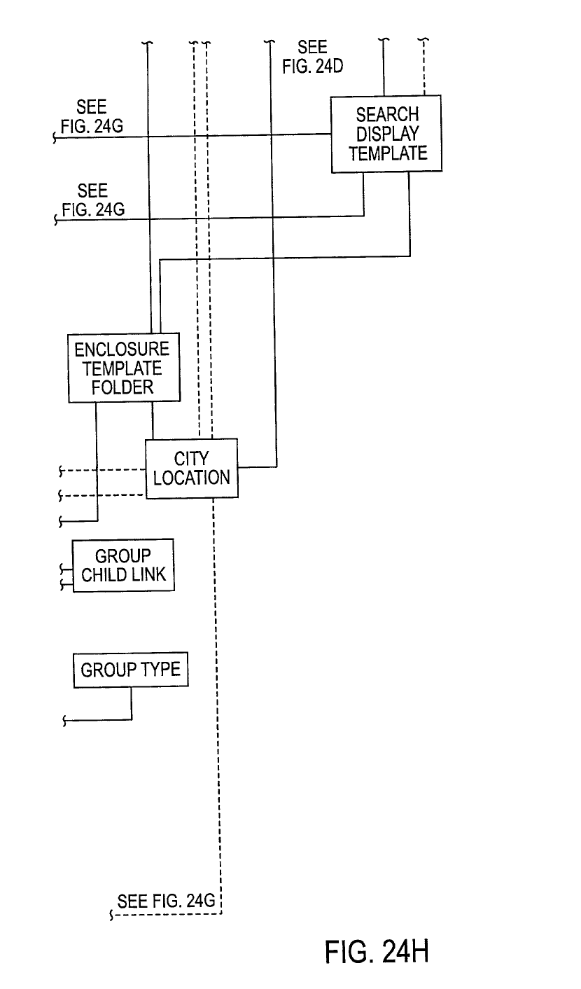

FIG. 24 is an exemplary diagram of a table layout of one embodiment of the invention. The exemplary embodiment includes source tables that provide information, such as MSDS acquisition tracking, material shipment, substance, resource, group type, country, state, unit of measure conversion, site property aims, material activity phase, manufacturer, expect plug, agency, industry class, material class, prior interpretation text, material acquisition training occupance log, image for, prior regulation paragraph, incident class, prior fields and values, internal codes tables and standard use industry. The exemplary embodiment also includes linking tables that link other tables, as well as provide information such as MSDS requests, material authorized person, material storage quantity, substance within, material/MSDS, language, material process, industry material, standard use industry, current regulation, current regulation paragraph, generic step, material regulation, process, process generic step, incident class form, incident class, agency forms, agency repeat forms, material transportation, material management office, material storage container, inventory record, material regulation limits, material training, standard terms, company link, MSDS standard, MSDS fields and values, material supplier, training occupance status, search terms, course category affiliation, train course attribute, course training occupancy, training regulation, without lookup list, material training, authorized person step, regulation access, authorized person access, process resource, process step access, MSDS folder, folder child link, MSDS industry group, process folder, site properties, company site, person locator, material use disposition, person link, course category hierarchy, person certification, certification, personal template, course category, person training projections, course notifications, certification requirements, person group, course prerequisite hierarchy, course category folder, training course, group course, template group, student person, group site, group, training for, regulation change notification, regulation folder, folder link, site folder, group folder, search display template, enclosure template folder, city location, group child link and MSDS change notification. Each table contains fields as commonly understood to belong to the category of the table name.

In the following figures, several exemplary tables are explained in terms of what fields may be helpful in various exemplary embodiments. Additional fields may be added, eliminated, or renamed without departing from the spirit and scope of the invention.

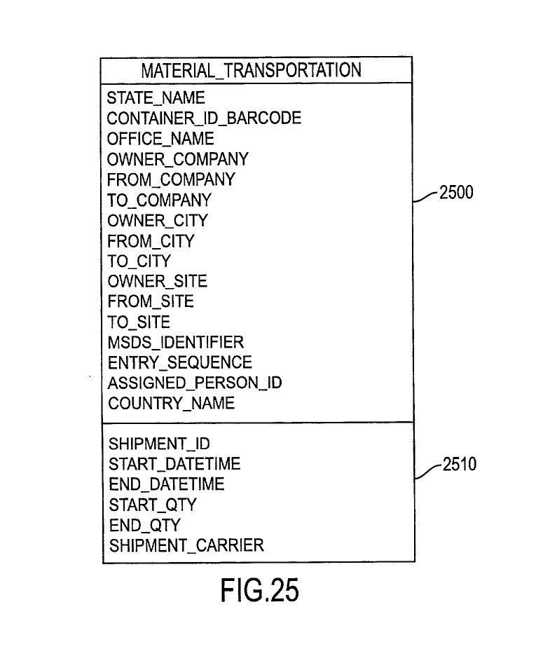

FIG. 25 is an exemplary material transportation table. The material transportation table can have sort fields 2500 and unsorted fields 2510. Sorted field 2500 can include state name, container ID barcode, office name, owner company, from company, to company, owner city, from city, to city, owner site, from site, to site, MSDS identifier, entry sequence, assigned person and country name. The unsorted fields 2510 can include shipment ID, start date/time, end date/time, start quantity, end quality and shipment carrier.

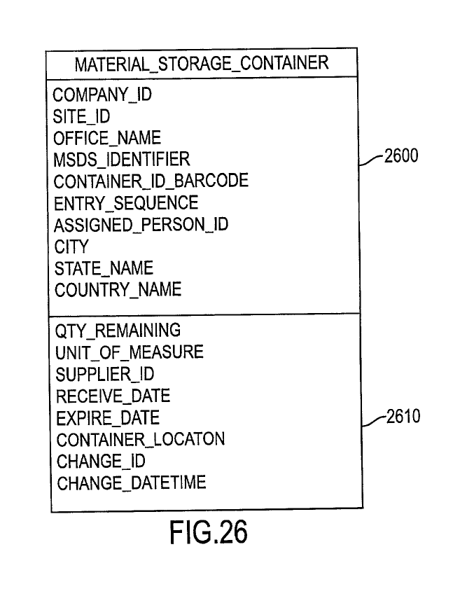

FIG. 26 is an exemplary material storage container table. The material storage container table can have sort fields 2600 and unsorted fields 2610. Sorted field 2600 can include company ID, site ID, office name, MSDS identifier, container ID barcode, entry sequence, assigned person ID, city, state and country. The unsorted fields 2610 can include quantity remaining, unit of measure, supplier ID, receive date, expired date, container location, change ID and change date/time.

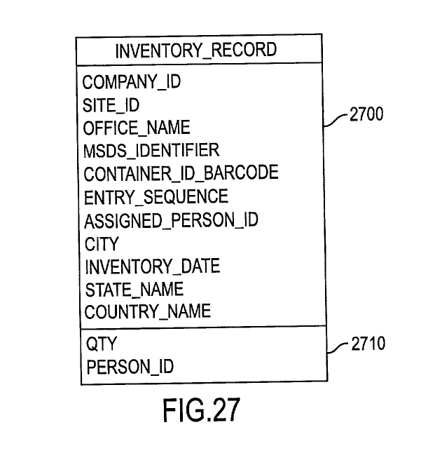

FIG. 27 is an exemplary inventory record table. The inventory record table can have sort fields 2700 and unsorted fields 2710. Sorted field 2700 can include company ID, site ID, office name, MSDS identifier, container ID barcode, entry sequence, assigned person ID, city, inventory date, state and country. The unsorted fields 2710 can include quantity and person ID.

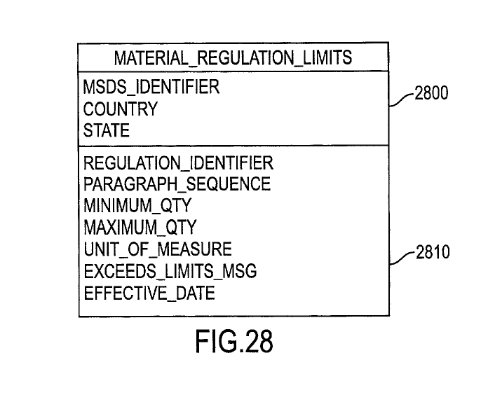

FIG. 28 is an exemplary material regulation limits table. The material regulation limits table can have sort fields 2800 and unsorted fields 2810. Sorted field 2800 can include MSDS identifier, country and state. The unsorted fields 2810 can include regulation identifier, paragraph sequence, minimum quality, maximum quality, unit of measure, exceed limits message and effective date.

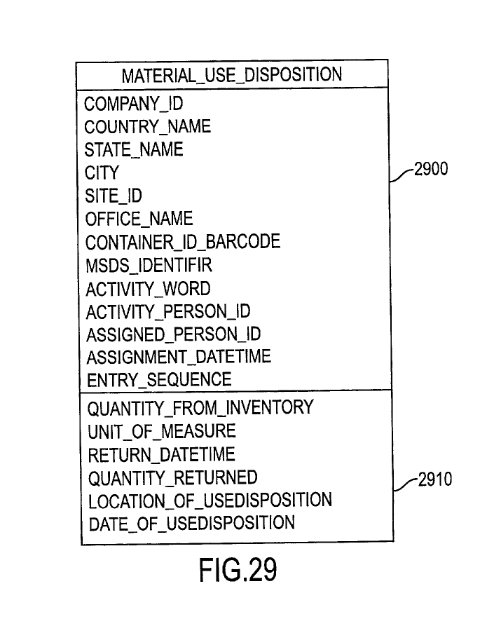

FIG. 29 is an exemplary material use and disposition table. The material use and disposition table can have sort fields 2900 and unsorted fields 2910. Sorted field 2900 can include company ID, country name, state name, city, site ID, office name, container ID barcode, MSDS identifier, activity word, activity person, assigned person, assignment date/time and entry sequence. The unsorted fields 2910 can include quantity from inventory, unit of measure, return date/time, quantity returned, location of use/disposition and date of use/disposition.

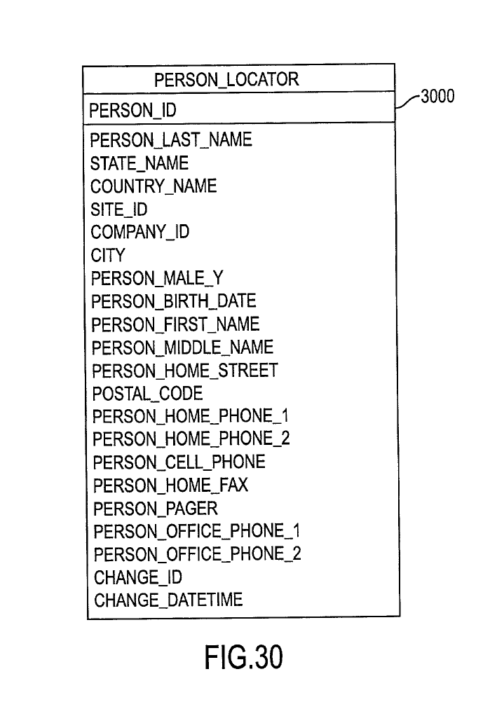

FIG. 30 is an exemplary person locator table 3000. The person locator table 3000 can include person, person last name, state, country, site, company, city, person mail, person birth date, person first name, person middle name, person home St., postal code, person home phone one, person home phone two, person cell phone, person home facsimile, person painter, person office phone one, person office phone two, change ID and change date/time.

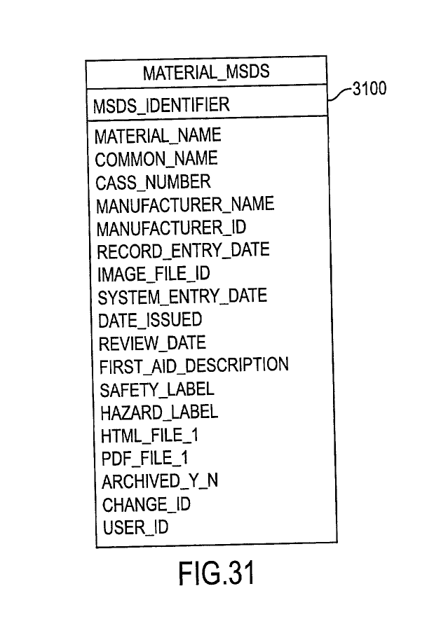

FIG. 31 is an exemplary material MSDS table 3100. The material MSDS table 3100 can include MSDS identifier, material name, common name, CASS number, manufacturer name, manufacturer ID, record entry date, image file, system entry date, date issued, review date, first aid description, safety label, hazard label, HTML file, PDF file, archived, change ID and userID.

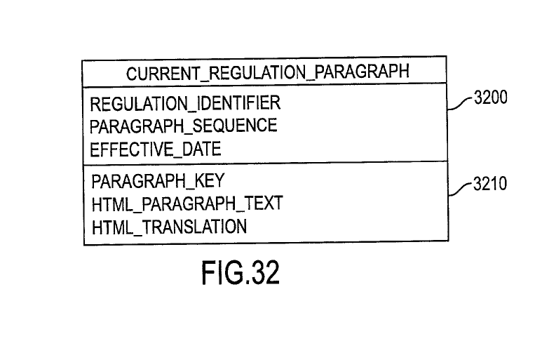

FIG. 32 is an exemplary current regulation paragraph table. The current regulation paragraph table can have sort fields 3200 and unsorted fields 3210. Sorted field 3200 can include regulation identifier, paragraph sequence and effective date. The unsorted fields 3210 can include paragraph key, HTML paragraph text and HTML translation.

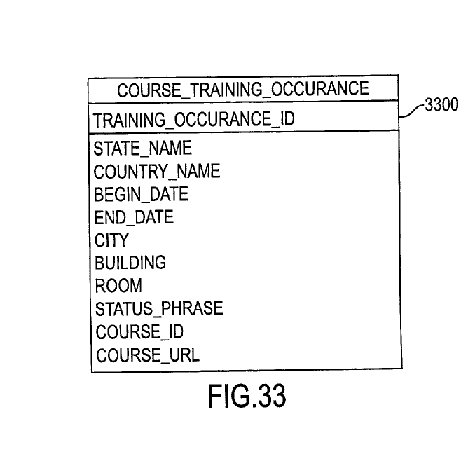

FIG. 33 is an exemplary course training occurrence table 3300. The course training occurrence table 3300 can include training currents, state, country, begin date, end date, city, building, room, status phrase, course ID and course URL.

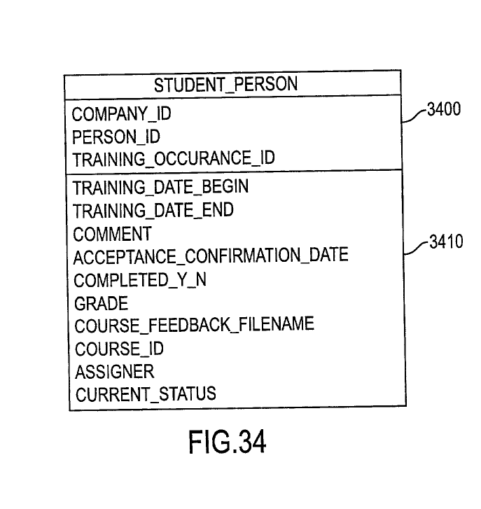

FIG. 34 is an exemplary student person table. The student person table can have sort fields 3400 and unsorted fields 3410. Sorted field 3400 can include company, person and training occurrence. The unsorted fields 3410 can include training begin date, training end date, comment, acceptance confirmation date, completed, parade, course feedback filename, course, assignor and current status.

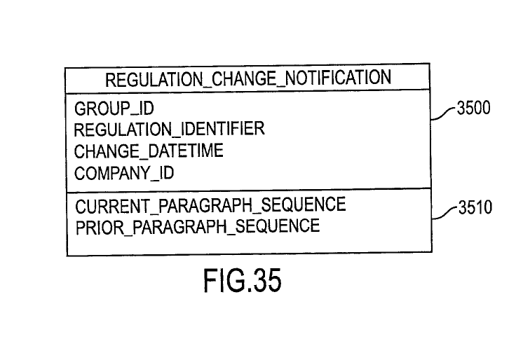

FIG. 35 is an exemplary regulation change notification table. The regulation change notification table can have sort fields 3500 and unsorted fields 3510. Sorted field 3500 can include group ID, regulation identifier, change date/time and company. The unsorted fields 3510 can include current paragraph sequence and prior paragraph sequence.

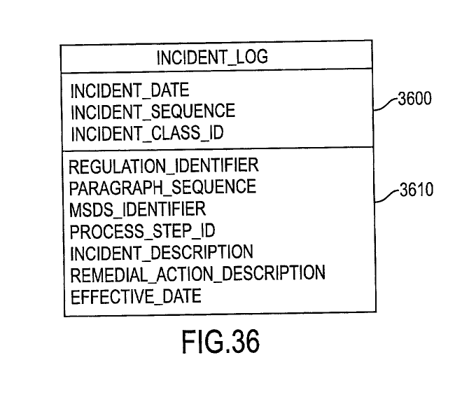

FIG. 36 is an exemplary incident log table. The incident log table can have sort fields 3600 and unsorted fields 3610. Sorted field 3600 can include incident date, incident sequence and incident class ID. The unsorted fields 3610 can include regulation identify, paragraph sequence, MSDS identifier, process step ID, incident description, remedial action description and effective date.

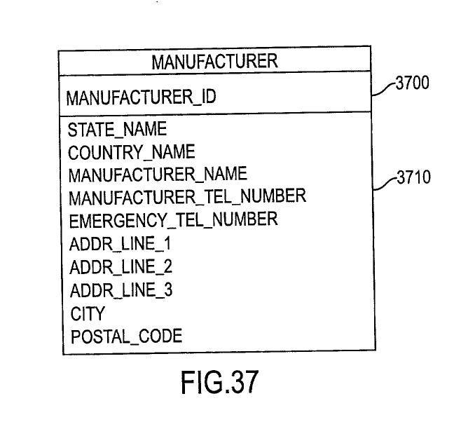

FIG. 37 is an exemplary manufacturer table. The manufacturer table can have sort fields 3700 and unsorted fields 3710. Sorted field 3700 can include manufacturer. The unsorted fields 3710 can include state, country, manufacturer name, manufacturer telephone number, emergency telephone number, address line 1, address line 2, address line 3, city and postal code.

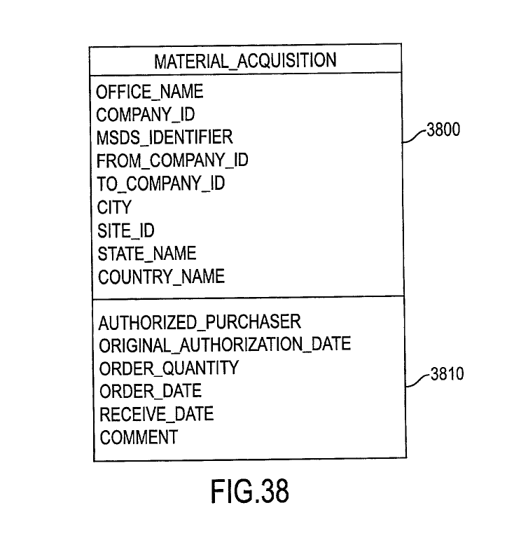

FIG. 38 is an exemplary material acquisition table. The material acquisition table can have sort fields 3800 and unsorted fields 3810. Sorted field 3800 can include office name, company, MSDS identifier, from company, to company, city, site ID, state and country. The unsorted fields 3810 can include authorized purchaser, original authorization date, order quantity, order date, received date and comment.

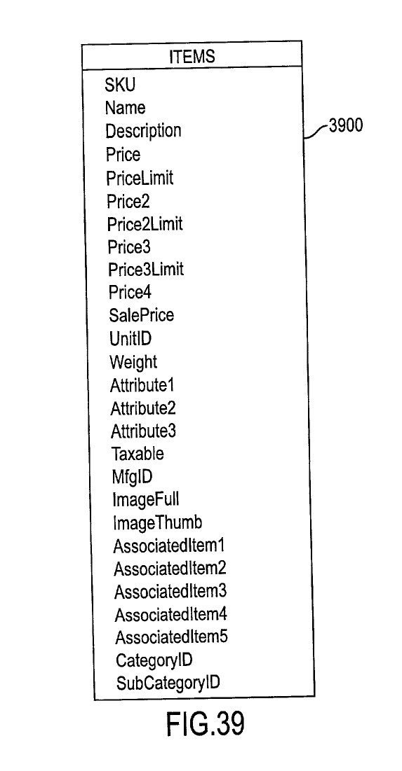

FIG. 39 is an exemplary items table 3900. The items table 3900 can include SKU, name, description, price, price limit, price 2, price 2 limit, price 3, price 3 limit, price 4, sale price, unitID, weight, attribute1, attribute2, attribute3, taxable, manufacturerID, image full, image thumbnail, associated item1, associated item2, associated item3, associated item4, associated item5, categoryID and subcategoryID.

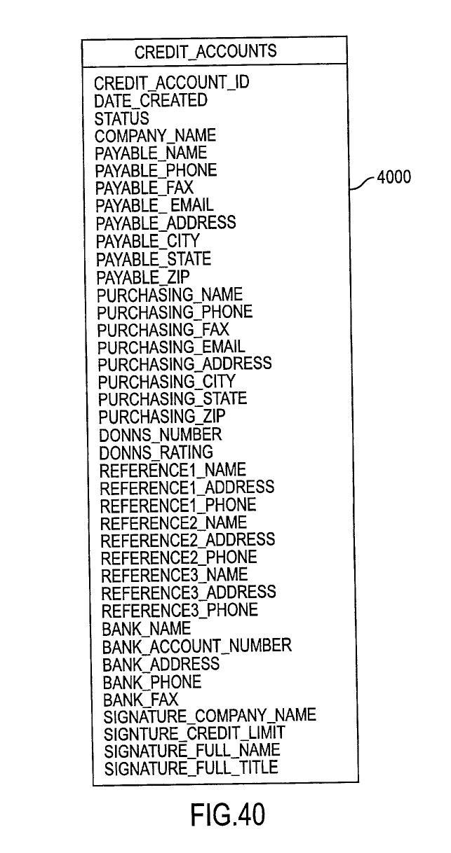

FIG. 40 is an exemplary credit accounts table 4000. The credit accounts table 4000 can include credit amount, credit status, date created, status, company may, payable name, payable phone, payable fax, payable email, payable address, payable city, payable state, payable zip, purchasing name, purchasing phone, purchasing fax, purchasing email, purchasing address, purchasing city, purchasing state, purchasing zip, Donns number, Donns rating, reference 1 name, reference 1 address, reference 1 phone, reference 2 name, reference 2 address, reference 2 phone, reference 3 name, reference 3 address, reference 3 phone, bank name, bank account number, bank address, bank phone, bank fax, signature company name, signature credit limit, signature full name and signature full title.

Although preferred embodiments of the present invention have been shown and described, it will be appreciated by those skilled in the art that changes may be made in these embodiments without departing from the principle and spirit of the invention, the scope of which is defined in the appended claims their equivalents.

What is claimed is:

1. A communications network-enabled method for determining and providing solutions to meet compliance and risk management standards and requirements, comprising:
asking, via a communications network, a user a plurality of questions in an electronic format that adapts a subsequent question based on a user inputted answer to a previous question;
determining applicability of at least one of a law, a statute, a regulation, an industry standard and a policy based on the answer;
determining enabling information, customized to the user's industry; and
assisting the user in prioritizing and allocating user resources to comply with the at least one of a law, a statute, a regulation, an industry standard and a policy that was determined to be applicable, based on the answer.

2. The method of claim 1, wherein the enabling information is at least one of a task to be completed, a training needed and a supply needed.

3. The method of claim 2, wherein the assisting further comprises recording the completion of the task, the training and a purchase of the supply.

4. The method of claim 3, further comprising reporting the completion of the task, the training and a purchase of a supply.

5. The method of claim 2, wherein the task to be completed is at least one of a policy to be implemented, a plan to be prepared, a test to be performed, a report to be at least one of filed, saved, and created and an information to be found.

6. The method of claim 2, wherein the training needed is at least one of an online training, a classroom training, a certification, a test and a test for sizing.

7. The method of claim 2, wherein the supply needed is at least one of a safety supply, a spill supply, a test equipment, a measuring equipment, a permit and a repair part.

8. The method of claim 2, wherein the task, the training and the supply are mandated by the at least one law, statute, regulation, industry standard and policy.

9. The method of claim 1, wherein the assisting further comprises scheduling or calendaring the user resources.

10. The method of claim 1, wherein the assisting further comprises presenting a training provider and a training course based on the training needed.

11. The method of claim 1, wherein the plurality of questions relates to at least one of chemicals, products, and structures located at a location.

12. The method of claim 1, wherein the plurality of questions relates to at least one of risk management, auditing checklists, corporate standards, market and industry standards and regulatory and interpretive actions.

13. The method of claim 1, wherein the enabling information is also customized to at least one of a users location, a vertical industry, a corporate policy and an industry standard.

14. The method of claim 1, further comprising:
recording the completion of the enabling information; and
determining a compliance score based on the answer and the completion of the enabling information.

15. A communications network-enabled apparatus for determining and providing solutions to meet compliance and risk management standards and requirements, comprising:
a questioning circuit, that asks a user a plurality of questions in an electronic format that adapts a subsequent question based on a user inputted answer to a previous question;
an applicability circuit that determines applicability of at least one of a law, a statute, a regulation, an industry standard and a policy based on the answer;
an enabling circuit that determines enabling information, customized to the user's industry; and
an assisting circuit that assists the user in prioritizing and allocating user resources to comply with the at least one of a law, a statute, a regulation, an industry standard and a policy that was determined to be applicable, based on the answer.

16. The apparatus of claim 15, wherein the enabling information is at least one of a task to be completed, a training needed and a supply needed.

17. The apparatus of claim 16, wherein the assisting circuit further records the completion of the task, the training and a purchase of the supply.

18. The apparatus of claim 17, further comprising a reporting circuit that reports the completion of the task, the training and a purchase of a supply.

19. The apparatus of claim 16, wherein the task to be completed is at least one of a policy to be implemented, a plan to be prepared, a test to be performed, a report to be at least one of filed, saved, and created and an information to be found.

20. The apparatus of claim 16, wherein the training needed is at least one of an online training, a classroom training, a certification, a test and a test for sizing.

21. The apparatus of claim 16, wherein the supply needed is at least one of a safety supply, a spill supply, a test equipment, a measuring equipment, a permit and a repair part.

22. The apparatus of claim 16, wherein the task, the training and the supply are mandated by the at least one law, statute, regulation, industry standard and policy.

23. The apparatus of claim 15, wherein the assisting circuit also schedules or calendars the user resources.

24. The apparatus of claim 15, wherein the assisting circuit also presents a training provider and a training course based on the training needed.

25. The apparatus of claim 15, wherein the plurality of questions relates to at least one of chemicals, products, and structures located at a location.

26. The apparatus of claim 15, wherein the plurality of questions relates to at least one of risk management, auditing checklists, corporate standards, market and industry standards and regulatory and interpretive actions.

27. The apparatus of claim 15, wherein the enabling information is also customized to at least one of a user's location, a vertical industry, a corporate policy and an industry standard.

28. The apparatus of claim 15, further comprising:
a recording circuit that records the completion of the enabling information; and
a determining circuit that determines a compliance score based on the answer and the completion of the enabling information.

29. A communications network-enabled system for determining and providing solutions to meet compliance and risk management standards and requirements, comprising:
a processor that asks a user a plurality of questions in an electronic format and adapts a subsequent question based on a user inputted answer to a previous question, that determines applicability of at least one of a law, a statute, a regulation, an industry standard and a policy based on an answer and determines enabling information, customized to the user's industry, and that assists the user in complying with the at least one of a law, a statute, a regulation, an industry standard and a policy that was determined to be applicable;
an input device that inputs information answering the plurality of questions;
a memory that stores the plurality of questions, the answer, the enabling information and the determined applicability of the at least one of the law, the regulation, the industry standard and the policy; and
an output device that displays the question, the answer, the enabling information and the applicability of the at least one of the law, the regulation, the industry standard and the policy, wherein the answer, the enabling information, and the applicability of the at least one of the law, the regulation, the industry standard and the policy is used to assist the user in prioritizing and allocating user resources.

30. The system of claim 29, wherein the enabling information is at least one of a task to be completed, a training needed and a supply needed.

31. The system of claim 30, wherein the memory also stores the completion of the task, the training and a purchase of the supply.

32. The system of claim 31, wherein the output device also displays the completion of the task, the training and a purchase of a supply.

33. The system of claim 30, wherein the task to be completed is at least one of a policy to be implemented, a plan to be prepared, a test to be performed, a report to be at least one of filed, saved, and created and an information to be found.

34. The system of claim 30, wherein the training needed is at least one of an online training, a classroom training, a certification, a test and a test for sizing.

35. The system of claim 30, wherein the supply needed is at least one of a safety supply, a spill supply, a test equipment, a measuring equipment, a permit and a repair part.

36. The system of claim 30, wherein the task, the training and the supply are mandated by the at least one law, statute, regulation, industry standard and policy.

37. The system of claim 29, wherein the assisting further comprises scheduling or calendaring the user resources.

38. The system of claim 29, wherein the output device also displays a training provider and a training course based on the training needed.

39. The system of claim 29, wherein the plurality of questions relates to at least one of chemicals, products, and structures located at a location.

40. The system of claim 29, wherein the plurality of questions relates to at least one of risk management, auditing checklists, corporate standards, market and industry standards and regulatory and interpretive actions.

41. The system of claim 29, wherein the enabling information is also customized to at least one of a user's location, a vertical industry, a corporate policy and an industry standard.

42. The system of claim 29, wherein the memory also stores the completion of the enabling information, and the processor also determines a compliance score based on the answer and the completion of the enabling information.
